(19) United States
(12) Patent Application Publication
(10) Pub. No.: US 2026/0200233 A1
(43) Pub. Date: Jul. 16, 2026

(54) SYSTEM INCLUDING LIQUID BOTTLE CONFIGURED TO STORE RECORDING LIQUID, TANK CONFIGURED TO STORE RECORDING LIQUID SUPPLIED FROM THE LIQUID BOTTLE, AND HOLE

(71) Applicant: BROTHER KOGYO KABUSHIKI KAISHA, Nagoya (JP)

(72) Inventors: Masahiro HAYASHI, Anjo (JP); Fumiya NAKAMURA, Nagoya (JP); Yuma TANABE, Nagoya (JP); Naoya OKAZAKI, Hashima (JP); Hirohide NAWATA, Nagoya (JP); Daiki OKAMOTO, Nagoya (JP); Hiromitsu TANAKA, Nagoya (JP); Yukihiko SATO, Nagoya (JP)

(73) Assignee: BROTHER KOGYO KABUSHIKI KAISHA, Nagoya (JP)

(21) Appl. No.: 19/559,722

(22) Filed: Mar. 6, 2026

Related U.S. Application Data
(63) Continuation of application No. PCT/JP2024/029972, filed on Aug. 23, 2024.

(30) Foreign Application Priority Data
Sep. 11, 2023 (JP) 2023-147161

(51) Int. Cl. B41J 2/175

(52) U.S. Cl. CPC B41J 2/17506; B41J 2/17596

(57) ABSTRACT

A system includes a liquid bottle, a tank, and a hole. The liquid bottle has a connection port. The liquid bottle is configured to store recording liquid. The tank has a connection receiving port configured to be connected to the connection port. The tank is configured to store the recording liquid. The hole surrounds the connection receiving port. In the system, the liquid bottle has a protrusion having the connection port. The protrusion is configured to be inserted in the hole. A shape of an outer peripheral surface of the protrusion in an axial direction in which a center axis of the protrusion extends corresponds to a shape of the hole. The shape of the outer peripheral surface of the protrusion in the axial direction is not rotationally symmetrical about a center of the protrusion.

### REFERENCE TO RELATED APPLICATIONS

This is a by-pass continuation application of International Application No. PCT/JP2024/029972 filed on August 23, 2024 which claims priority from Japanese Patent Application No. 2023-147161 filed on September 11, 2023. The entire content of the priority application is incorporated herein by reference.

### BACKGROUND ART

There is a system including an ink bottle and an ink tank to which the ink bottle is connected. In the system, the ink bottle includes an annular abutment surface and a circular-shaped supply port. Upon the connection of the ink bottle to the ink tank, the abutment surface comes into contact with the upper end of an annular wall portion of the ink tank. The supply port is positioned at the center portion of the abutment surface and provides a communication between the inside of the ink bottle and the outside. A needle positioned at the center of the wall portion of the ink tank is configured to be inserted in the supply port. Accordingly, ink in the ink bottle and air in the ink tank can be exchanged with each other through the needle. As a result, ink is supplied from the inside of the ink bottle to the inside of the ink tank.

### SUMMARY

In the system, the supply port is positioned at the center of the abutment surface. Hence, the needle can be inserted in the supply port irrespective of the orientation of the ink bottle about the imaginary line passing through the center of abutment surface. Accordingly, upon the connection of the ink bottle to the ink tank, the orientation of the ink bottle about the imaginary line is not limited.

Here, from the viewpoint of design flexibility, in a case where the supply port is disposed at a position offset from the center of the abutment surface, the needle is also disposed at a position offset from the center of the wall portion for achieving the insertion of the needle in the supply port, for example. However, since the supply port is at the position offset from the center of the abutment surface, the needle can be inserted in the supply port of the ink bottle in an only one direction. Accordingly, for connecting the ink bottle to the ink tank, a user is required to set the orientation of the ink bottle to an appropriate orientation. That is, there is difficulty for the user in connecting the ink bottle to the ink tank. Hence, the supply port is not disposed at the position offset from the center of the abutment surface.

The present disclosure is made in view of the foregoing and an object of the present disclosure is to provide a system and a liquid bottle capable of enhancing design flexibility.

In order to attain the above and other objects, according to one aspect, the present disclosure provides a system including a liquid bottle, a tank, and a hole. The liquid bottle has a connection port. The liquid bottle is configured to store recording liquid. The tank has a connection receiving port configured to be connected to the connection port. The tank is configured to store the recording liquid supplied from the liquid bottle through the connection port. The hole surrounds the connection receiving port. The hole has a cylindrical shape. In the system, the liquid bottle has a protrusion having the connection port. The protrusion is configured to be inserted in the hole. A shape of an outer peripheral surface of the protrusion in an axial direction in which a center axis of the protrusion extends corresponds to a shape of the hole. The shape of the outer peripheral surface of the protrusion in the axial direction is not rotationally symmetrical about a center of the protrusion.

According to another aspect, the present disclosure also provides a liquid bottle configured to store recording liquid. The liquid bottle includes a connection port through which recording liquid is to be supplied to a tank, and a protrusion. The connection port is configured to be connected to a connection receiving port of the tank. The protrusion has the connection port. The protrusion is configured to be inserted in a hole. The hole has a cylindrical shape and surrounds the connection receiving port of the tank. In the liquid bottle, a shape of an outer peripheral surface of the protrusion in an axial direction in which a center axis of the protrusion extends corresponds to a shape of the hole. The outer peripheral surface of the protrusion in the axial direction is not rotationally symmetrical about a center of the protrusion.

In the above structures, the outer peripheral surface of the protrusion has a shape, which corresponds to the shape of the inner peripheral surface of the hole. Also, the outer peripheral surface of the protrusion is not rotationally symmetrical about the center of the protrusion. Accordingly, the insertion of the protrusion into the hole is allowed in only one direction. Hence, a user can easily connect the liquid bottle and the tank to each other, regardless of the positions of the connection port and the connection receiving port. As a result, high flexibility can be obtained in designing the liquid bottle and the tank.

### BRIEF DESCRIPTION OF DRAWINGS

FIG. 1 is an external perspective view of a multifunction peripheral 10.

FIG. 2 is a longitudinal cross-sectional view of a printer section 11 schematically illustrating an internal structure of the printer section 11.

FIG. 3 is a plan view illustrating an arrangement of a carriage 23 and an ink tank 100.

FIG. 4 is a perspective view of an ink tank set 51.

FIG. 5 is a perspective view of the ink tank 100.

FIG. 6 is a top view of a tank cap 127.

FIG. 7 is a front view of the tank cap 127.

FIG. 8 is a right side view of the tank cap 127.

FIG. 9 is a rear view of the tank cap 127.

FIG. 10 is a bottom view of the tank cap 127.

FIG. 11 is a longitudinal cross-sectional view of the tank cap 127.

FIG. 12 is a partial cross-sectional view illustrating a state where each tank cap 127 is attached to a corresponding circular-shaped wall 122.

FIG. 13 is a longitudinal cross-sectional view illustrating a state where each tank cap 127 is attached to the corresponding circular-shaped wall 122.

FIG. 14 is a perspective view of a liquid bottle 80.

FIG. 15 is a schematic view illustrating a center C1 of a protrusion 94.

FIG. 16 is a longitudinal cross-sectional view of the liquid bottle 80 in a state where a valve 161 is positioned at a closed position.

FIG. 17 is a longitudinal cross-sectional view of the liquid bottle 80 in a state where the valve 161 is positioned at an opening position.

FIG. 18 is a cross-sectional view illustrating an area S1 of an air passage G and an area S2 of an ink passage F.

FIG. 19 is a schematic view illustrating the protrusion 94 according to variations.

FIG. 20 is a schematic view illustrating the protrusion 94 according to variations.

FIG. 21 is a schematic view illustrating the protrusion 94 according to variations.

FIG. 22 is a cross-sectional view illustrating the tank cap 127 according to variations.

FIG. 23 is a perspective view illustrating a state where a nozzle cap 301 is attached to the liquid bottle 80, which is capable of filling ink to the ink tank 100 of the printer section 11.

FIG. 24 is a front view of the nozzle cap 301 of the liquid bottle 80, which is capable of filling ink to the ink tank 100 of the printer section 11.

FIG. 25 is a plan view of the nozzle cap 301 of the liquid bottle 80, which is capable of filling ink to the ink tank 100 of the printer section 11.

FIG. 26 is a right side view illustrating a state where the nozzle cap 301 is attached to the liquid bottle 80, which is capable of filling ink to the ink tank 100 of the printer section 11.

FIG. 27 is a plan view of the liquid bottle 80 in a state where the nozzle cap 301 is not attached to the liquid bottle 80.

### DESCRIPTION

### Overall Configuration of Image Forming Apparatus

Hereinafter, an embodiment of the present disclosure will be described. It should be understood that the following embodiment is merely an example of the disclosure, and that this embodiment may be modified as appropriate without departing from the spirit of the disclosure. In the following description, a direction from the starting point to the end point of one of unidirectional arrows that constitute a bidirectional arrow is referred to as an orientation, both directions of the bidirectional arrow are collectively referred to as a direction. In other words, the orientation of the unidirectional arrow is a component of the direction. Both an upward orientation and a downward orientation are components of an up-down direction and are opposite each other. Both a leftward orientation and a rightward orientation are components of a left-right direction and are opposite each other. Both a frontward orientation and a rearward orientation are components of a front-rear direction and are opposite each other. Also, in this embodiment, the up-down direction corresponds to the direction of gravity and the front-rear direction and left-right direction correspond to the horizontal direction.

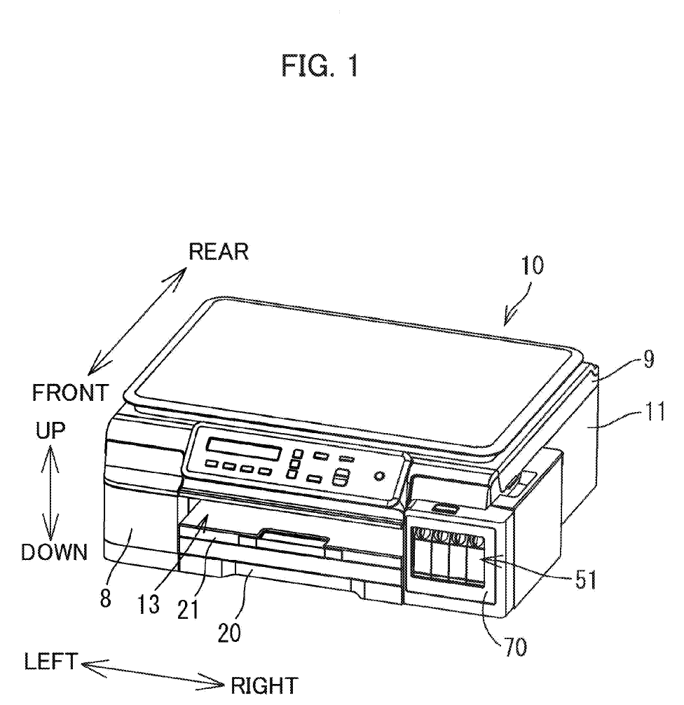

Further, the up-down direction is defined based on a state or an orientation of a multifunction peripheral 10 which is placed and ready for use. The front-rear direction is defined based on the assumption that the portion of the multifunction peripheral 10 at which an opening 13 is disposed is a front portion. The left-right direction is defined based on the perspective of a user viewing the multifunction peripheral 10 from the front portion. The state of the multifunction peripheral 10 shown in FIG. 1 will be sometimes referred to as the “usable state”. The orientation of the multifunction peripheral 10 shown in FIG. 1 will be sometimes referred to as the “usable orientation”. The front surface of the multifunction peripheral 10 is at the front portion of the multifunction peripheral 10, at which the opening 13 is disposed.

### Overall Configuration of the Multifunction Peripheral 10

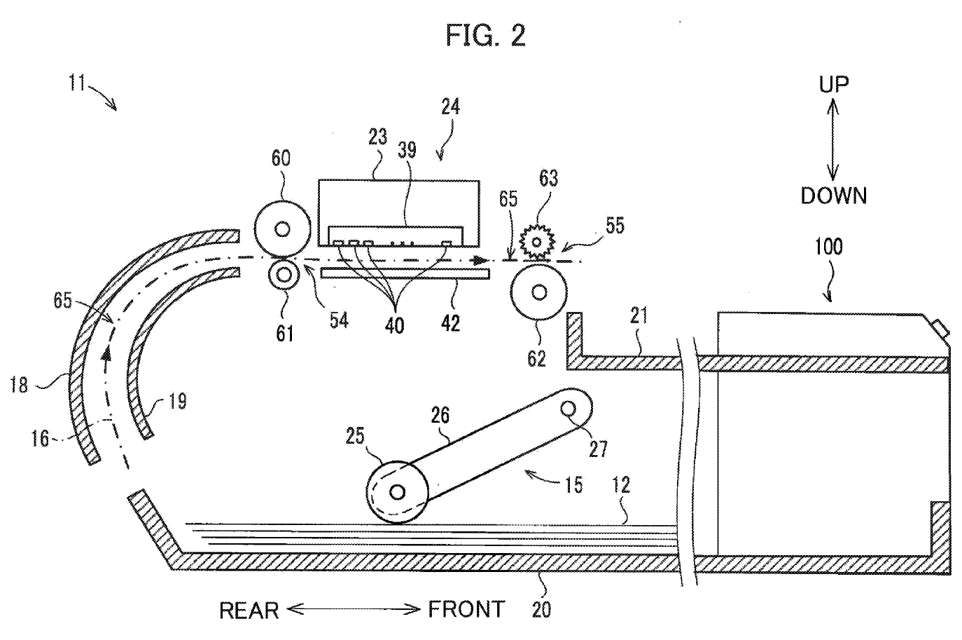

As illustrated in FIG. 1, the multifunction peripheral 10 includes a casing 8 having a generally rectangular-parallelepiped shape. The multifunction peripheral 10 includes a scanning section 9 and a printer section 11 in the inner space of the casing 8. The scanning section 9 is positioned the upper portion of the inner space of the casing 8. The scanning section 9 has a scanning function. The printer section 11 is positioned further downward than the scanning section 9 in the inner space of the casing 8. The printer section 11 has a printing function. The printer section 11 is configured to record images on sheets 12 illustrated in FIG. 2 based on an inkjet recording method. As illustrated in FIG. 2, the printer section 11 includes a feeding section 15, a feeding tray 20, a discharging tray 21, a conveying path 65, a conveying roller section 54, a recording section 24, a discharging roller section 55, a platen 42, and an ink tank set 51.

### The Feeding Tray 20 and the Discharging Tray 21

As illustrated in FIG. 1, the opening 13 is positioned at the center in the left-right direction of the front portion of the multifunction peripheral 10. The feeding tray 20 is movable in the front-rear direction through the opening 13 with user’s operation. As illustrated in FIG. 2, the feeding tray 20 is configured to support a plurality of the sheets 12 stacked on the feeding tray 20. The discharging tray 21 is positioned further upward than the feeding tray 20. The discharging tray 21 is movable in the front-rear direction with the feeding tray 20. The discharging tray 21 is configured to support the sheets 12 discharged by the discharging roller section 55.

### The Feeding Section 15

The feeding section 15 is configured to convey the sheets 12 supported on the feeding tray 20 to the conveying path 65. As illustrated in FIG. 2, the feeding section 15 includes a feeding roller 25, a feeding arm 26, and a shaft 27. The feeding roller 25 is rotatably supported by the feeding arm 26 at the end portion of the feeding arm 26. Since a drive force is transmitted from a conveying motor (illustration is omitted) to the feeding roller 25, the feeding roller 25 is rotated in a direction so that the sheet 12 is conveyed in a conveying direction 16. Hereinafter the rotations of the feeding roller 25, a conveying roller 60, and a discharging roller 62 in the direction each of which conveys the sheet 12 in the conveying direction 16 are referred to as a “forward rotation”. The feeding arm 26 is pivotally movably supported by the shaft 27 which is supported by the frame of the printer section 11. The feeding arm 26 is urged by its own weight or by an elastic force generated with a spring or the like so as to pivotally move toward the feeding tray 20.

### The Conveying Path 65

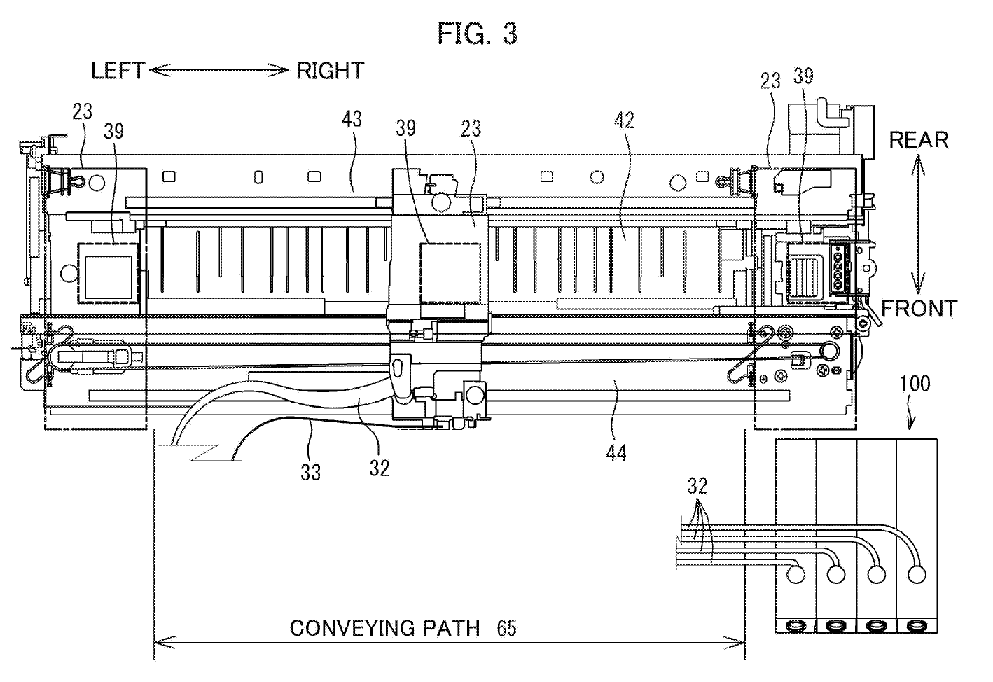

As illustrated in FIG. 2, the conveying path 65 refers to a space which is defied by an outer guide member 18 and an inner guide member 19 facing each other at a predetermined interval, for example. The conveying path 65 extends from the rear end portion of the feeding tray 20 to the rear portion of the printer section 11 and extends from the bottom to the top at the rear portion of the printer section 11 while making a U-turn. Then, the conveying path 65 extends through a space between the recording section 24 and the platen 42 to the discharging tray 21. As illustrated in FIGS. 2 and 3, the portion of the conveying path 65 between the conveying roller section 54 and the discharging roller section 55 is positioned approximately at the center of the multifunction peripheral 10 in the left-right direction, and extends in the front-rear direction. In FIG. 2, the conveying direction 16 of the sheet 12 in the conveying path 65 is indicated with a one-dot chain arrow.

### The Conveying Roller Section 54

As illustrated in FIG. 2, the conveying roller section 54 is positioned further upstream than the recording section 24 in the conveying direction 16. The conveying roller section 54 includes the conveying roller 60 and a pinch roller 61. The conveying roller 60 and the pinch roller 61 face each other in the up-down direction. Since a drive force of the conveying motor is transmitted to the conveying roller 60, the conveying roller 60 is rotated. The pinch roller 61 is rotated in accordance with the rotation of the conveying roller 60. Since the conveying roller 60 is rotated forward by the forward rotation of the conveying motor, the sheet 12 is nipped between the conveying roller 60 and the pinch roller 61 and is conveyed in the conveying direction 16.

### The Discharging Roller Section 55

As illustrated in FIG. 2, the discharging roller section 55 is positioned further downstream than the recording section 24 in the conveying direction 16. The discharging roller section 55 includes a discharging roller 62 and a spur 63. The discharging roller 62 and the spur 63 face each other in the up-down direction. Since a drive force of the conveying motor is transmitted to the discharging roller 62, the discharging roller 62 is rotated. The spur 63 is rotated in accordance with the rotation of the discharging roller 62. Since the discharging roller 62 rotates forward by the forward rotation of the conveying motor, the sheet 12 is nipped between the discharging roller 62 and the spur 63, and is conveyed in the conveying direction 16.

### The Recording Section 24

As illustrated in FIG. 2, the recording section 24 is positioned between the conveying roller section 54 and the discharging roller section 55 in the conveying direction 16. The recording section 24 face the platen 42 in the up-down direction. The conveying path 65 is between the recording section 24 and the platen 42 in the up-down direction. The recording section 24 is positioned further upward than the conveying path 65 in the up-down direction. The recording section 24 includes a carriage 23 and a recording head 39.

As illustrated in FIG. 3, the carriage 23 is supported by guide rails 43 and 44. The guide rails 43 and 44 are supported by the frame of the printer section 11. The guide rails 43 and 44 are apart from each other in the front-rear direction. Each of the guide rails 43 and 44 extends in the left-right direction. The carriage 23 is mounted to a known belt mechanism disposed at the guide rail 44. Since a drive force is transmitted from a carriage motor (illustration is omitted) to the belt mechanism, the belt mechanism is rotated. When the belt mechanism is rotated, the carriage 23 moves in the left-right direction. In FIG. 3, the movement range of the carriage 23 is indicated with a one-dot chain line. The carriage 23 is configured to move further rightward than the conveying path 65 and is configured to move further leftward than the conveying path 65 in the left-right direction.

The ink tank 100 and the recording head 39 are connected to each other by ink tubes 32. A control board, on which a control unit is mounted, and the recording head 39 are electrically connected to each other by a flexible flat cable 33. Note that the illustration of the control board is omitted. The ink tubes 32 and the flexible flat cable 33 extend from the carriage 23. The ink tubes are configured to supply ink stored in the ink tank 100 to the recording head 39. The flexible flat cable 33 is configured to transmit control signals output from the control unit to the recording head 39.

As illustrated in FIG. 2, the recording head 39 is mounted on the carriage 23. A plurality of nozzles 40 are positioned at the lower surface of the recording head 39. The recording head 39 is configured to eject ink from the nozzles 40 in the form of minute ink droplets. In a process where the carriage 23 moves, the recording head 39 ejects ink droplets to the sheet 12 supported by the platen 42. Accordingly, images are recorded on the sheet 12.

### The Platen 42

As illustrated in FIGS. 2 and 3, the platen 42 is positioned between the conveying roller section 54 and the discharging roller section 55 in the conveying direction 16. The platen 42 faces the recording section 24 in the up-down direction. The platen 42 is configured to support the sheet 12 conveyed by the conveying roller section 54 from below.

### The Ink Tank Set 51

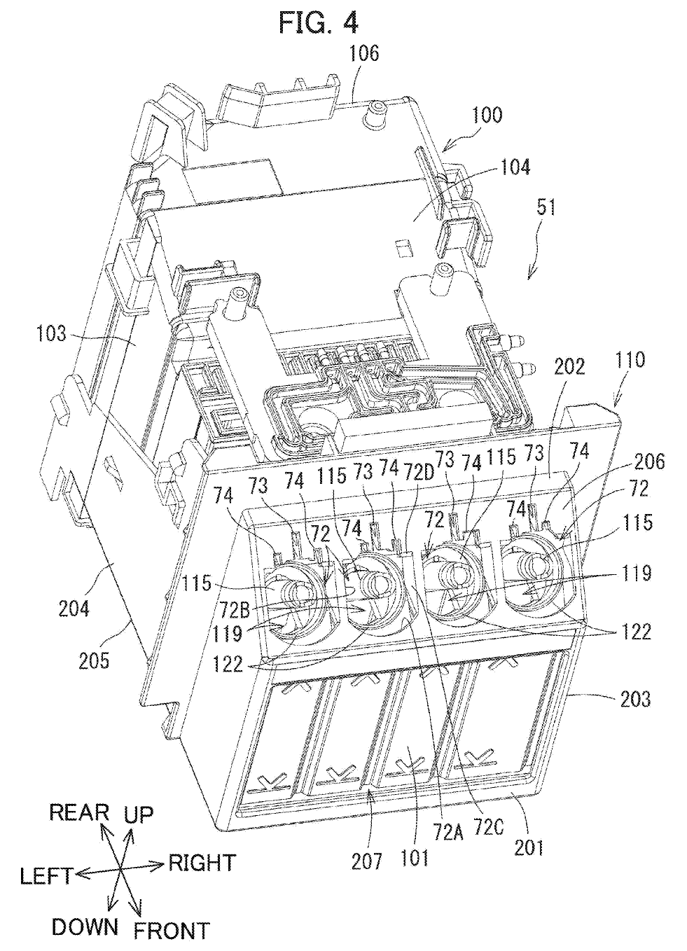

As illustrated in FIG. 4, the ink tank set 51 includes the ink tank 100, a tank cover 110, and tank caps 127. The ink tank 100 is an example of the tank. Note that the illustration of the tank caps 127 are omitted in FIG. 4. As illustrated in FIG. 1, the ink tank set 51 is positioned in the multifunction peripheral 10. The ink tank set 51 is fixed to the multifunction peripheral 10 such that a user cannot detach the ink tank set 51 easily from the multifunction peripheral 10. An opening is positioned at the right end in the left-right direction of the front surface of the casing 8 of the multifunction peripheral 10. The ink tank set 51 is positioned further rearward than the opening of the casing 8.

A cover 70 is disposed on the casing 8. The cover 70 is positioned further frontward than the opening of the casing 8. The cover 70 is pivotally movable centered on a pivot shaft which is positioned at the lower end of the casing 8 in the up-down direction and extends in the left-right direction. The cover 70 is pivotally movable from a covering position illustrated in FIG. 1 to an exposing position. At the covering position, the cover 70 covers the opening of the casing 8. At the exposing position, the opening of the casing 8 is exposed to the outside of the multifunction peripheral 10. In other words, the cover 70 is pivotally movable from the covering position illustrated in FIG. 1, at which the cover 70 covers the ink tank set 51, and the exposing position, at which the ink tank set 51 is exposed to the outside of the multifunction peripheral 10. The cover 70 has an opening. Even when the cover 70 is positioned at the covering position, part of the ink tank set 51 is exposed to the outside of the multifunction peripheral 10 through the opening of the cover 70. Here, “part of the ink tank set 51 is exposed to the outside of the multifunction peripheral 10 through the opening of the cover 70” signifies that a user can see at least part of the ink tank set 51 through the opening of the cover 70 and does not signify that part of the ink tank set 51 protrudes toward the outside of the multifunction peripheral 10.

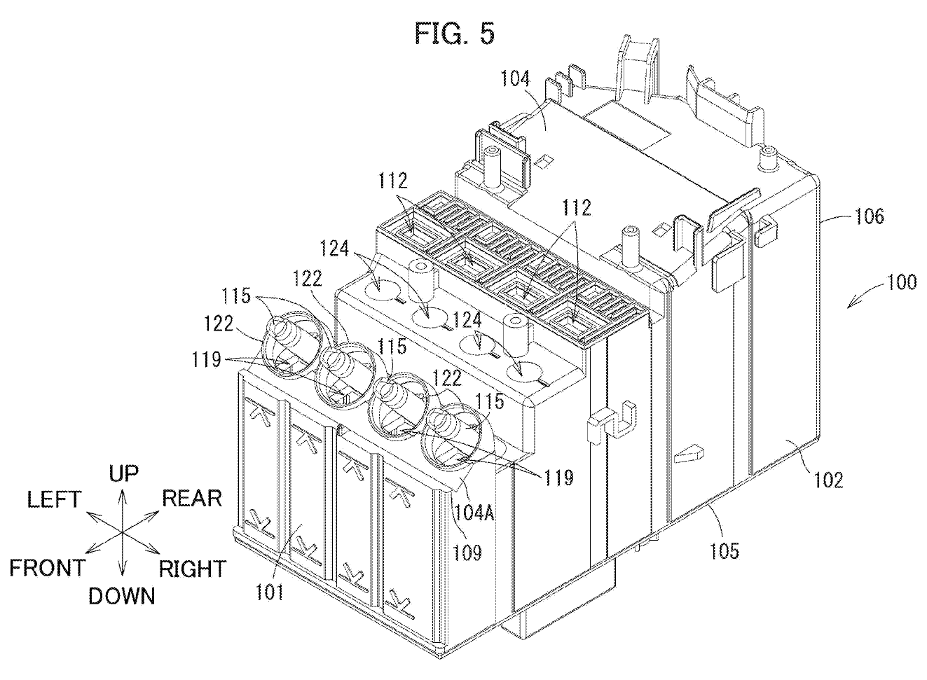

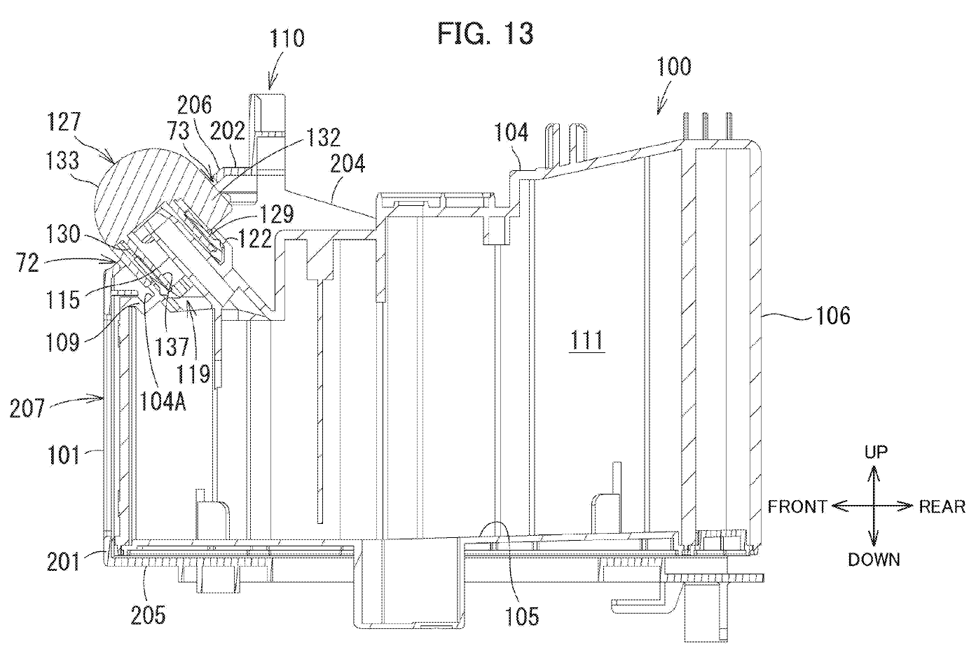

As illustrated in FIGS. 5 and 13, the ink tank 100 includes four ink chambers 111 in the ink tank 100. The four ink chambers 111 are arranged in the left-right direction. The four ink chambers 111 are partitioned in the left-right direction with partition walls which are positioned apart from each other in the left-right direction. Each of the partition walls has a plate shape extending in the front-rear direction and the up-down direction. Each ink chamber 111 is configured to store ink whose color is different from the colors of ink stored in the remaining three ink chambers 111. Specifically, each ink chamber 111 is configured to store ink having the corresponding one color of black, yellow, cyan, and magenta. Ink is an example of the liquid for recording. Each ink chamber 111 is an example of the storage chamber. Note that one of the ink chambers 111 is illustrated in FIG. 13.

As illustrated in FIGS. 4 and 5, the ink tank 100 has a general rectangular parallelepiped external shape. The ink tank 100 includes a front wall 101, a right wall 102, a left wall 103, an upper wall 104, a lower wall 105, and a rear wall 106. The front wall 101, the right wall 102, the left wall 103, the upper wall 104, the lower wall 105, and the rear wall 106 define the ink chambers 111, which is configured to store ink. The ink tank 100 are molded as a single piece by injection molding using resin material, for example. Among the outer walls of the ink tank 100, the lower wall 105 may be a component molded separately, for example. Each of the front wall 101, the right wall 102, the left wall 103, the upper wall 104, the lower wall 105, and the rear wall 106 has a translucency that allows the ink levels in the ink tank 100 to be visible from the outside of the ink tank 100.

The upper surface of the upper wall 104 is constituted by multiple surfaces. Each of the multiple surfaces extends in the front-rear direction and the left-right direction. The upper wall 104 has air communication ports 112. The ink chambers 111 and the outside of the ink tank 100 are in communication through the air communication ports 112. The air communication ports 112 extend through the upper wall 104 in the up-down direction. The upper surface of the upper wall 104 has a sloped surface 104A. The sloped surface 104A is positioned at the front end portion of the upper surface of the upper wall 104. The sloped surface 104A is sloped relative to the front-rear direction such that the sloped surface 104A extends downward as the sloped surface 104A extends frontward. The sloped surface 104A extends from the left edge of the ink tank 100 to the right edge of the ink tank 100. As illustrated in FIGS. 5 and 13, a weir wall 109 is positioned at the front end of the sloped surface 104A. The weir wall 109 protrudes diagonally frontward and upward from the sloped surface 104A. The weir wall 109 extends from the left edge of the ink tank 100 to the right edge of the ink tank 100 in the left-right direction. The weir wall 109 is an example of the second rib. Also, the weir wall 109 is an example of the first rib.

Outflow tubes 124 are positioned at the upper wall 104. The outflow tubes 124 are circular tubes extending downward from the upper wall 104 through the ink chambers 111. The lower ends of the outflow tubes 124 are positioned near the lower wall 105. The openings defined by the upper ends of the outflow tubes 124 are positioned at the upper wall 104. Each ink tube 32 is connected to the corresponding one of the upper ends of the outflow tubes 124. Ink stored in the ink chambers 111 flows into the recording head 39 through the outflow tubes 124 and the ink tubes 32. Since ink is ejected from the recording head 39, ink stored in the ink chambers 111 is consumed. As a result, air flows into the ink chambers 111 through the air communication ports 112.

Circular-shaped walls 122 are positioned at the front end portion of the upper wall 104. Each circular-shaped wall 122 has a cylindrical shape, and surrounds the corresponding one of the communication ports 119 and the corresponding one of the tank tubes 115. Each circular-shaped wall 122 extends diagonally upward and frontward from the front end portion of the upper wall 104 in an extending direction crossing both the direction of gravity and the horizontal direction. In other words, each circular-shaped wall 122 extends parallel to the corresponding one of the tank tubes 115. Each tank tube 115 protrudes further upward than the distal edge of the corresponding circular-shaped wall 122. Each circular-shaped wall 122 is an example of the cylindrical wall.

Each tank tube 115 is positioned inside the corresponding circular-shaped wall 122. Each tank tube 115 is a circular tube extending upward and frontward beyond the upper surface of the upper wall 104 in the extending direction, which crosses both the direction of gravity and the horizontal direction. Each tank tube 115 has an upper end which is open in the outside of the corresponding ink chamber 111. Each tank tube 115 has a lower end which is open in the inside of the corresponding ink chamber 111. Each tank tube 115 has an inner space providing a communication between the outside and the inside of the corresponding ink chamber 111. Each tank tube 115 is positioned further rearward than the center of the corresponding circular-shaped wall 122. In other words, the axes each of which extends through the center of the corresponding tank tube 115 are positioned further rearward than the axes each of which extends through the center of the corresponding circular-shaped wall 122 when viewed in the extending direction, in which the tank tubes 115 extend. The upper end of each of tank tubes 115 is divided in the left-right direction into two lip portions. Each tank tube 115 is an example of the first nozzle.

Each communication port 119 is positioned in the corresponding circular-shaped wall 122 of the sloped surface 104A. The communication ports 119 extend through the upper wall 104 in the up-down direction. The front portion of each communication port 119 has a circular shape, and the rear portion of each communication port 119 has a rectangular shape. In other words, each communication port 119 has a quadrilateral shape whose front portion is convex outward in an arc shape. Each communication port 119 provides a communication between the outside and the inside of the corresponding ink chamber 111. Each communication port 119 is positioned further frontward than the corresponding tank tube 115. Each communication port 119 positioned further downward than the corresponding tank tube 115. In other words, the straight line of the communication port 119 passing through the center of the communication port 119 and extending in the extending direction, in which the tank tubes 115 extends, is positioned further frontward than the axis of the tank tubes 115, which passes through the center of the tank tubes 115, when viewed in the extending direction. Each communication port 119 is positioned further frontward than the center of the corresponding circular-shaped wall 122. In other words, the straight line of the communication port 119, which passes through the center of the communication port 119 and extends in the extending direction, is positioned further frontward than the axis of the circular-shaped wall 122, which passes through the center of the circular-shaped wall 122, when viewed in the extending direction, in which the circular-shaped wall 122 extends. Each communication port 119 is an example of the first communication port. Each tank tube 115 and each communication port 119 are examples of the connection receiving port.

As illustrated in FIG. 4, the tank cover 110 holds the ink tank 100 while the tank cover 110 covers the front portion of the ink tank 100 from the front. The tank cover 110 includes a front wall 201, an upper wall 202, a right wall 203, a left wall 204, a lower wall 205, and a sloped wall 206. The front wall 201 covers the front portion of the ink tank 100. The front wall 201 has an opening 207. Part of the front wall 101 of the ink tank 100 is exposed to the front of the tank cover 110 through the opening 207. Here, “part of the front wall 101 of the ink tank 100 is exposed to the front of the tank cover 110 through the opening 207” signifies that at least a user can see part of the front wall 101 from the front of the tank cover 110 through the opening 207, and does not signify that part of the front wall 101 protrudes further frontward than the tank cover 110 through the opening 207.

The upper wall 202 covers part of the front portion of the upper wall 104 of the ink tank 100. The right wall 203 covers part of the right wall 102 of the ink tank 100. The left wall 204 covers part of the left wall 103 of the ink tank 100. The lower wall 205 covers part of the lower wall 105 of the ink tank 100.

The sloped wall 206 is connected to the upper end of the front wall 201 and is connected to the front end of the upper wall 202. The sloped wall 206 is positioned further upward than the circular-shaped walls 122 of the ink tank 100. The sloped wall 206 is positioned further frontward than the circular-shaped walls 122 of the ink tank 100. In other words, the sloped wall 206 is positioned relative to the circular-shaped walls 122 in a direction in which the circular-shaped walls 122 extend from the front end portion of the upper wall 104 in the extending direction. The outer surface of the sloped wall 206 crosses both the direction of gravity and the horizontal direction. The outer surface of the sloped wall 206 slopes relative to the front-rear direction such that the outer surface of the sloped wall 206 extends downward as the outer surface of the sloped wall 206 extends frontward. The sloped wall 206 covers part of the sloped surface 104A of the upper wall 104 of the ink tank 100.

The sloped wall 206 has four through-holes 72. The four through-holes 72 are arranged at intervals in the left-right direction. Each through-hole 72 extends through the sloped wall 206 in the up-down direction. The sloped wall 206 has inner peripheral surfaces defining the through-holes 72. Hereinafter, each inner peripheral surface defining the corresponding through-hole 72 will be described as “the inner peripheral surface of the through-hole 72”. The inner peripheral surface of each through-hole 72 has a cylindrical shape extending in a direction orthogonal to the outer surface of the sloped wall 206, i.e., extending upward and forward. In other words, each through-hole 72 has a cylindrical shape. Here, “a cylindrical shape” signifies the shape of an inner peripheral surface that surrounds an area to form an enclosed space. Thus, the shape of an opening defined by the inner peripheral surface does not necessarily have a circular shape. Furthermore, the inner peripheral surface of each through-hole 72 is regarded as having a cylindrical shape regardless of the length of the inner peripheral surface of the through-hole 72 extending in a direction in which the opening defined by the inner peripheral surface faces, i.e., regardless of the thickness of each through-hole 72. The inner peripheral surface of each through-hole 72 surrounds the corresponding circular-shaped wall 122 when viewed from a diagonal viewpoint, that is, from the above and front. Each of the four through-holes 72 is positioned so as to correspond to the respective one of the four ink chambers 111. That is, each of the four through-holes 72 overlaps the corresponding one of the four ink chambers 111 when viewed from a diagonal viewpoint, that is, from the above and front. Each circular-shaped wall 122 and each communication port 119 are exposed to the outside of the tank cover 110 through the corresponding through-hole 72. As illustrated in FIG. 13, Each tank tube 115 protrudes to the outside of the tank cover 110 through the corresponding through-hole 72. The inner peripheral surface of each through-hole 72 is an example of the hole portion.

Each through-hole 72 has the front portion and the rear portion. The front portion of the through-hole 72 has a circular shape and the rear portion of the through-hole 72 has a rectangular shape. In other words, each through-hole 72 has a quadrilateral shape whose front portion is convex outward in an arc shape. Specifically, the inner peripheral surface of each through-hole 72 has an inner curved surface 72A, a left inner flat surface 72B, a right inner flat surface 72C, and a rear inner flat surface 72D. The inner curved surface 72A is convex outward toward the front and the lower. The left inner flat surface 72B is connected to the left end of the inner curved surface 72A. The right inner flat surface 72C is connected to the right end of the inner curved surface 72A. The rear inner flat surface 72D connects the rear end of the left inner flat surface 72B and the rear end of the right inner flat surface 72C. The inner curved surface 72A is positioned at the lower portion of the inner peripheral surface of each through-hole 72. The rear inner flat surface 72D has a shape such that the center portion of the rear inner flat surface 72D in the left-right direction is convex outward toward the upper and the rear. The inner peripheral surface of each through-hole 72 is an example of the hole portion. The inner curved surface 72A is an example of the second curved surface. The rear inner flat surface 72D is an example of the second flat surface.

In each through-hole 72, a slit 73 extends rearward from the rear inner flat surface 72D of the through-hole 72. In each through-hole 72, the slit 73 shares a space with the through-hole 72. The slit 73 is positioned at the center of the rear inner flat surface 72D of the through-hole 72 in the left-right direction while the slit 73 shares a space with the corresponding through-hole 72.

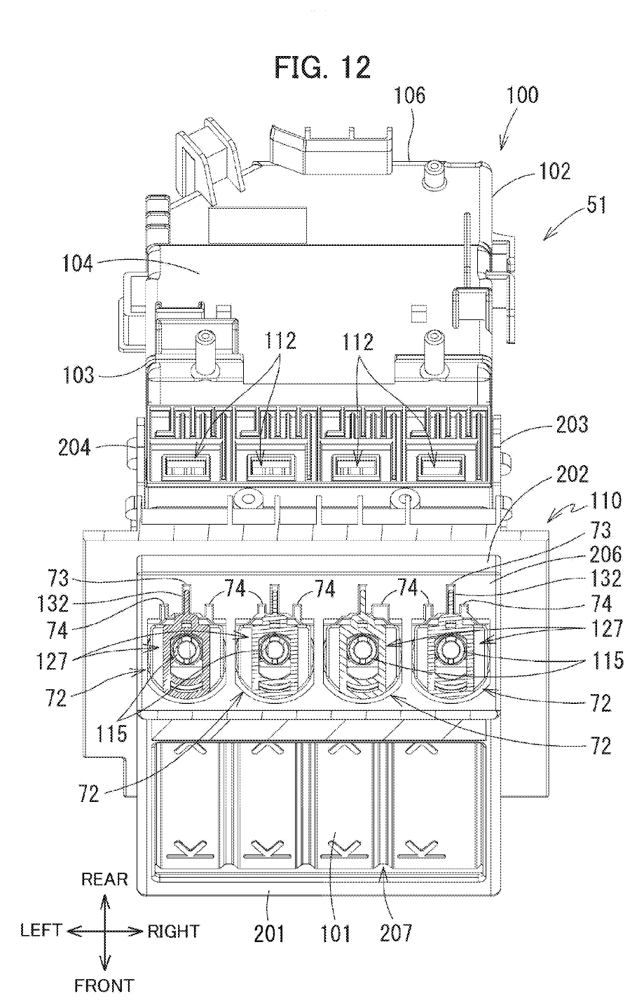

As illustrated in FIGS. 4 and 12, in each through-hole 72, key grooves 74 are selectively positioned at the rear inner flat surface 72D of the through-hole 72. The key grooves 74 are positioned the left and/or the right relative to the slit 73. The key grooves 74 extend downward from the rear inner flat surface 72D of the through-hole 72 while key grooves 74 share a space with the corresponding through-hole 72. In each in each through-hole 72, the presence or absence, position, and shape of each key groove 74 are different. Specifically, in the through-hole 72 positioned at the leftmost in FIGS. 4 and 12, one of the key grooves 74 is positioned further rightward than the slit 73 and the other key groove 74 is positioned further leftward than the slit 73. The length between the one key groove 74 (i.e., the right key groove 74) and the slit 73 in the left-right direction is the same as the length between the other key groove 74 (i.e., the left key groove 74) and the slit 73 in the left-right direction.

In the through-hole 72 which is the second from the left in FIGS. 4 and 12, one of the key grooves 74 is positioned further rightward than the slit 73 and the other key groove 74 is positioned further leftward than the slit 73. The length between the one the key groove 74 (i.e., the right key groove 74) and the slit 73 in the left-right direction is longer than the length between the other key groove 74 (i.e., the left key groove 74) and the slit 73 in the left-right direction.

In the through-hole 72 which is the third from the left in FIGS. 4 and 12, one key groove 74 is positioned further rightward than the slit 73 and no key groove 74 is positioned further leftward than the slit 73. The length in the left-right direction of the one key groove 74 is longer than the length in the left-right direction of each key groove 74 in the through-hole 72 which is the second from the left.

In the through-hole 72 which is positioned at the rightmost in FIGS. 4 and 12, one of the key grooves 74 is positioned further rightward than the slit 73 and the other key groove 74 is positioned further leftward than the slit 73. The length between the one key groove 74 (i.e., the right key groove 74) and the slit 73 in the left-right direction is shorter than the length between the other key groove 74 (i.e., the left key groove 74) and the slit 73 in the left-right direction.

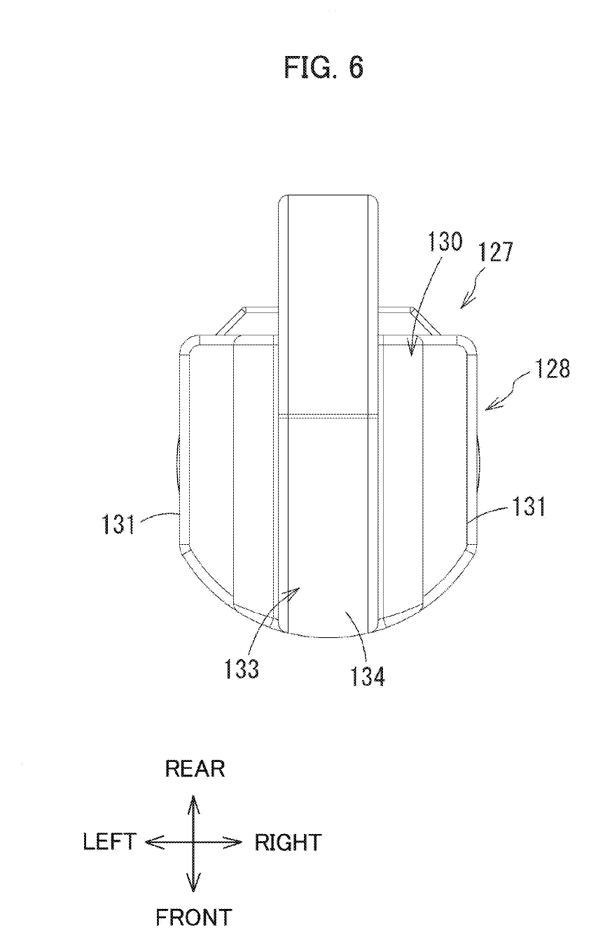

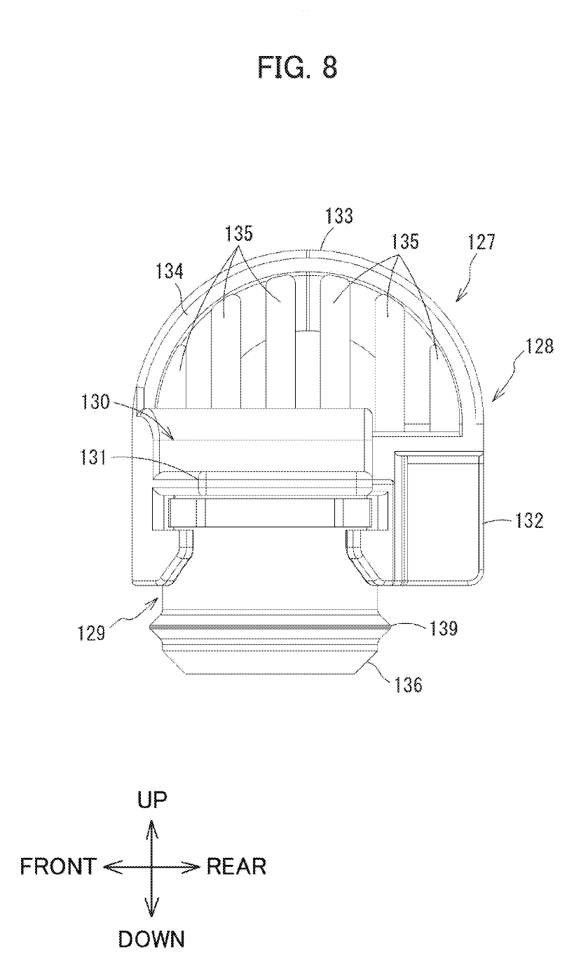

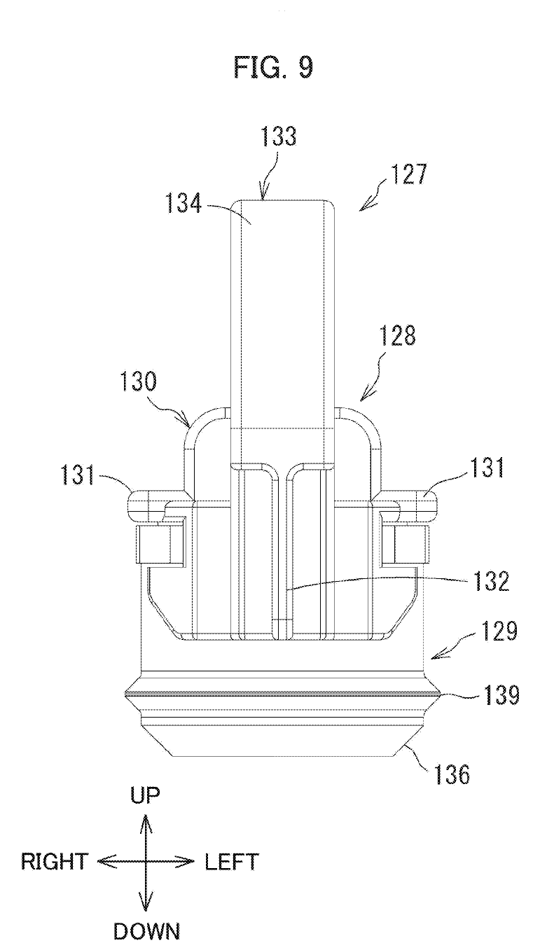

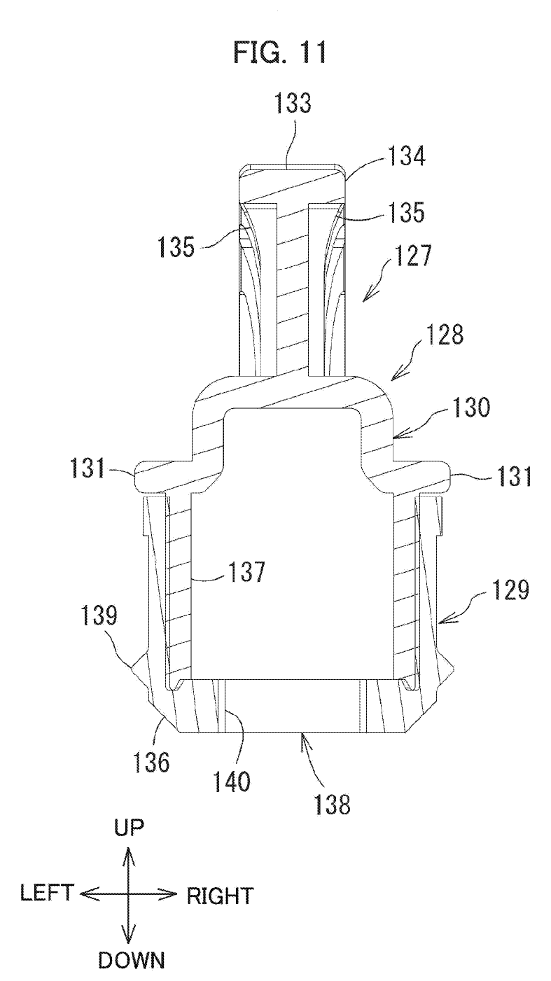

As illustrated in FIGS. 6 through 12, a tank cap 127 is a cylindrical member whose one end is closed. The tank cap 127 is an example of the cap. The tank cap 127 is detachably attachable to the circular-shaped wall 122. In a state where the tank cap 127 is detached from the circular-shaped wall 122, the tank cap 127 is not connected to both the ink tank 100 and the tank cover 110, and the tank cap 127 is completely separated from both the ink tank 100 and the tank cover 110. That is, the ink tank set 51 does not include a holding member, which includes an arm, for holding the tank cap 127 detached from the circular-shaped wall 122 in a connected state where the tank cap 127 is connected to both the ink tank 100 and the tank cover 110.

The tank cap 127 includes a main body 128, a rubber 129, and a grip portion 133. The main body 128 and the grip portion 133 are molded as a single piece using a synthetic resin. The rubber 129 is made of a rubber. The main body 128 includes a tubular portion 130, two protruding pieces 131, and a flat plate portion 132.

The tubular portion 130 has a cylindrical shape. The tubular portion 130 opens downward in an attached posture where the tank cap 127 is attached to the circular-shaped wall 122. The inner diameter of the inner space of the tubular portion 130 is greater than the outer diameter of the tank tube 115.

In a state where the tank cap 127 is in the attached posture, one protruding piece 131 protrudes leftward in the left-right direction from the side surface of the tubular portion 130 and the other protruding piece 131 protrudes rightward in the left-right direction from the side surface of the tubular portion 130. That is, the pair of protruding pieces 131 protrude in opposite directions from the side surface of the tubular portion 130. Each protruding piece 131 has a flat plate shape. Each protruding piece 131 has a protruding edge having a straight shape in the front-rear direction in a state where the tank cap 127 is in the attached posture.

In a state where the tank cap 127 is in the attached posture, the flat plate portion 132 protrudes rearward in the front-rear direction from the side surface of the tubular portion 130. The flat plate portion 132 extends in the up-down direction. The tank cap 127 has a shape such that the tank cap 127 is secured in the attached posture due to the flat plate portion 132 being fitted in the slit 73 of the tank cover 110.

The rubber 129 is positioned further downward than the protruding piece 131 at the side surface of the tubular portion 130. The rubber 129 has a cylindrical shape. The rubber 129 covers a portion of the side surface of the tubular portion 130 positioned further downward than the protruding pieces 131. The upper end of the rubber 129 is in contact with the protruding pieces 131.

The rubber 129 has a contact portion 136. The contact portion 136 extends inward from the opening of the tubular portion 130. The contact portion 136 is in contact with the end surface of the opening of the tubular portion 130. The contact portion 136 is in contact with an inner peripheral surface 137 of the tubular portion 130 at the inside of the opening of the tubular portion 130.

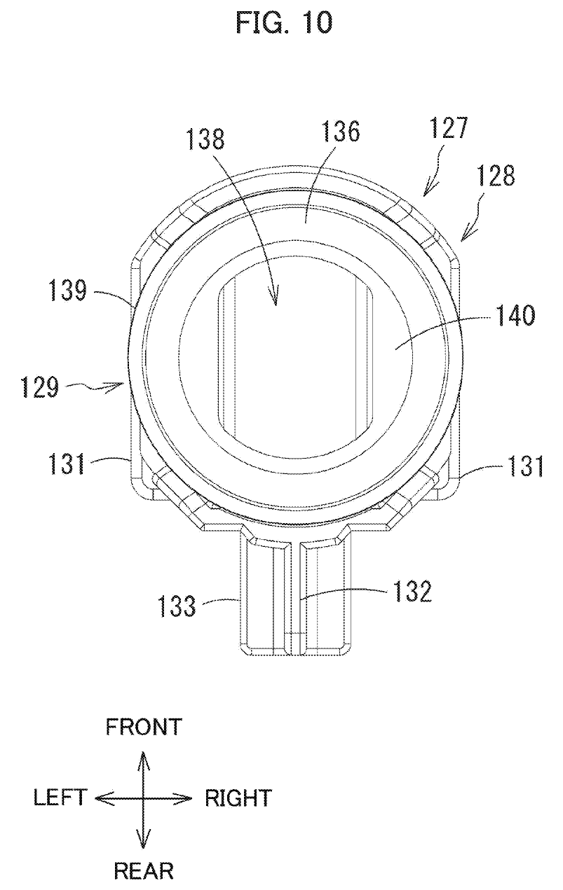

As illustrated in FIG. 10, a flange portion 140 extends inward from the contact portion 136 toward the inside of the tubular portion 130. The contact portion 136 and the flange portion 140 define an opening 138 opening downward. The flange portion 140 extends rightward from the left end of the contact portion 136 in the left-right direction. The flange portion 140 extends leftward from the right end of the contact portion 136 in the left-right direction. The flange portion 140 is not positioned at the upper end and the lower end of the contact portion 136. The length of the opening 138 in the front-rear direction is longer than the length of the opening 138 in the left-right direction. In other words, the opening 138 has an oblong shape, which is formed by straightening the left portion and the right portion of a circle. The length of the opening 138 in the left-right direction is longer than the outer diameter of the tank tube 115 of the ink tank 100.

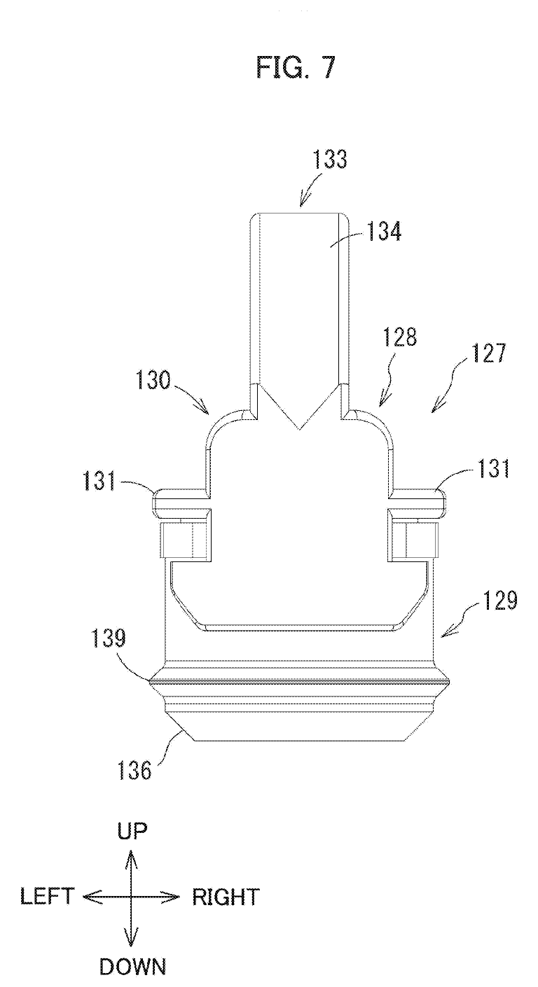

As illustrated in FIG. 7, the rubber 129 has a protruding portion 139 that annularly protrudes from the outer peripheral surface of the rubber 129. The outer diameter of the protruding portion 139 is greater than the inner diameter of the corresponding circular-shaped wall 122 of the ink tank 100. The rubber 129, which is fixed to the tubular portion 130, is configured to be inserted in the internal space of the circular-shaped wall 122 by press-fitting. In a state where the tubular portion 130 and rubber 129 are inserted in the internal space of the corresponding circular-shaped wall 122, the tubular portion 130 and the rubber 129 cover the upper portion of the corresponding communication port 119 and the upper portion of the corresponding tank tube 115. The protruding portion 139 is configured to be in liquid-tight contact with the inner peripheral surface of the corresponding circular-shaped wall 122. The main body 128 and the rubber 129 are examples of the cap main body.

In the attached posture, the grip portion 133 is positioned further upward than the tubular portion 130 and flat plate portion 132. The grip portion 133 has a semicircular plate shape that protrudes upward from both the outer surface of the tubular portion 130 and the outer surface of the flat plate portion 132 in the attached posture. The diameter of the semicircular plate shape is approximately the same as the total length of both the tubular portion 130 in the front-rear direction and the flat plate portion 132 in the front-rear direction. Hence, the grip portion 133 extends across both the tubular portion 130 and flat plate portion 146 and has a slender shape in the left-right direction.

The edge of the grip portion 133, which constitutes the circumference of the semicircular plate shape, is a thick-walled portion 134 extending in the left-right direction. Ridges 135 extend in the up-down direction from the bottom edge of the grip portion 133 toward the thick-walled portion 134. The plurality of the ridges 135 are arranged at intervals in the front-rear direction. Each ridge 135 has a length in the left-right direction gradually increasing while the ridge 135 extends from the bottom edge of the grip portion 133 to the thick-walled portion 134. Near the thick-walled portion 134, the length of each ridge 135 in the left-right direction is the same as the length of the thick-walled portion 134 in the left-right direction. The remaining portion of the grip portion 133 excluding the thick-walled portion 134 and the ridges 135 has a length in the left-right direction smaller than the length of the thick-walled portion 134 in the left-right direction.

The weight of the grip portion 133 is heavier than the total weight of both the main body 128 and the rubber 129. Hence, when the one of the pair of protruding pieces 131 is in contact with the floor, the grip portion 133 is also in contact with the floor. As a result, the portion of the tank cap 127 on the rubber 129 side relative to the protruding pieces 131 is raised from the floor. The main body 128 and the rubber 129 are examples of the cap main body. The grip portion 133 is an example of the grip portion.

### Liquid Bottle 80

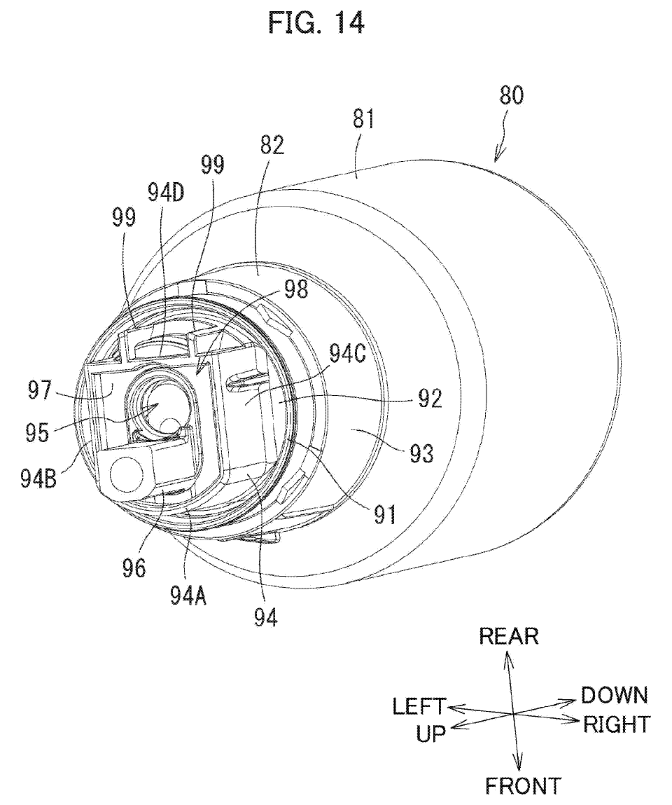

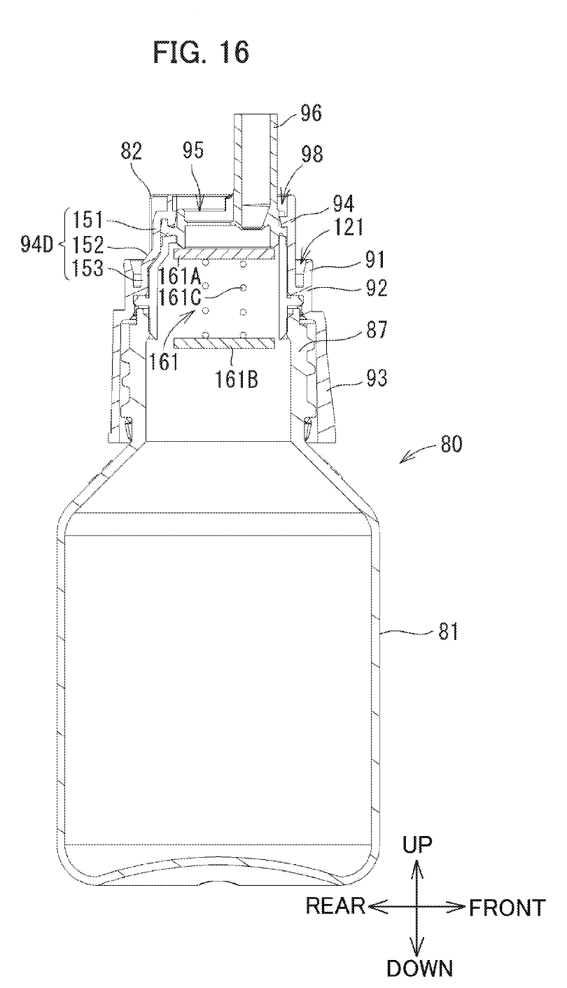

The liquid bottle 80 illustrated in FIG. 14 is configured to be connected to the ink tank set 51. The liquid bottle 80 and the ink tank set 51 are examples of the system. As illustrated in FIGS. 14 and 16, the liquid bottle 80 includes a bottle main body 81, a bottle cap 82, and a valve 161. The bottle main body 81 has a cylindrical shape and has a neck portion 87 at the upper portion of the bottle main body 81. The diameter of the neck portion 87 is smaller than the diameter of the lower portion of the bottle main body 81. Since the bottle cap 82 is attached to the neck portion 87, a container, which stores ink in the inner space of the container, is formed.

The bottle cap 82 includes a side wall 93, a bottom wall 92, a protrusion 94, an opening 95, a bottle tube 96, a key member 99, and an annular rib 91. The side wall 93 is a cylindrical wall extending in the up-down direction. The side wall 93 is connected to the neck portion 87 by one or more screws. The bottom wall 92 is an annular wall extending inward in a radial direction from the upper end of the side wall 93.

The protrusion 94 is a cylindrical wall extending upward from the bottom wall 92. The protrusion 94 is configured to be inserted in the corresponding through-hole 72 of the tank cover 110. The shape of the outer peripheral surface of the protrusion 94 corresponds to the shape of the inner peripheral surface of the corresponding through-hole 72. In other words, the shape and size of the outer peripheral surface of the protrusion 94 are approximately the same as the shape and size of the inner peripheral surface of the corresponding through-hole 72. That is, the shape of the outer peripheral surface of the protrusion 94 in an axial direction in which the center axis of the protrusion 94 extends corresponds to the shape of the corresponding through-hole 72. The front portion of the outer peripheral surface of the protrusion 94 is circular and the rear portion of the outer peripheral surface of the protrusion 94 is rectangular. In other words, the outer peripheral surface of the protrusion 94 has a quadrilateral shape whose front portion is convex outward in an arc shape.

Specifically, the outer peripheral surface of the protrusion 94 has an outer curved surface 94A, a left outer flat surface 94B, a right outer flat surface 94C, and a rear outer flat surface 94D. The outer curved surface 94A is convex outward. The left outer flat surface 94B is connected to the left end of the outer curved surface 94A. The right outer flat surface 94C is connected to the right end of the outer curved surface 94A. The rear outer flat surface 94D connects the rear end of the left outer flat surface 94B and the rear end of the right outer flat surface 94C to each other. In a state where the protrusion 94 is inserted in the corresponding through-hole 72: the outer curved surface 94A corresponds to the inner curved surface 72A of the corresponding through-hole 72; the left outer flat surface 94B corresponds to the right inner flat surface 72C of the corresponding through-hole 72; the right outer flat surface 94C corresponds to the left inner flat surface 72B of the corresponding through-hole 72. The rear outer flat surface 94D is at a position such that the opening 95 and the bottle tube 96 are positioned between the rear outer flat surface 94D and the outer curved surface 94A in the front-rear direction. As illustrated in FIGS. 14 and 16, the rear outer flat surface 94D has an upper flat surface 151, a middle sloped surface 152, and a lower arc-shaped surface 153. The upper flat surface 151 is positioned from the upper end of the protrusion 94 to the center portion of the protrusion 94 in the up-down direction. The middle sloped surface 152 is continuous with the lower end of the upper flat surface 151. The middle sloped surface 152 is sloped relative to the up-down direction such that the middle sloped surface 152 extends rearward as the middle sloped surface 152 extends downward. The lower arc-shaped surface 153 is positioned from the lower end of the middle sloped surface 152 to the upper surface of the bottom wall 92. The lower arc-shaped surface 153 is an arc-shaped surface which is convex rearward when viewed from the above. In a state where the protrusion 94 is inserted in the corresponding through-hole 72, the rear outer flat surface 94D corresponds to the rear inner flat surface 72D of the corresponding through-hole 72.

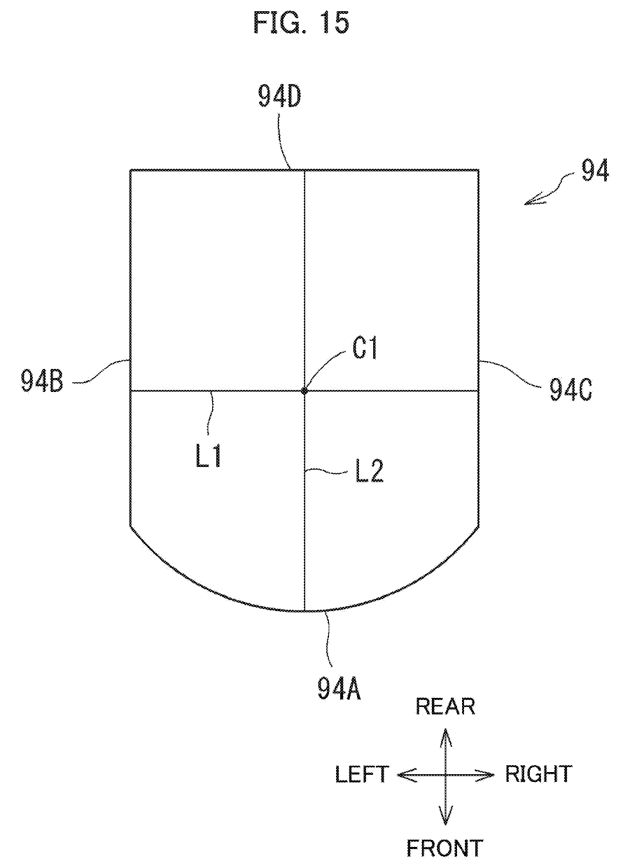

As illustrated in FIG. 15, the outer peripheral surface of the protrusion 94 does not have a rotational symmetry about a center C1 of the protrusion 94. That is, the outer peripheral surface of the protrusion 94 in the axial direction does not have a rotational symmetry about a center C1 of the protrusion 94. The rotational symmetry signifies that an object coincides with itself two or more times when the object is rotated 360 degrees about its center as the rotational axis. For example, in a case where the outer peripheral surface of the protrusion 94 is an equilateral triangle, when the protrusion 94 is rotated 360 degrees about the center C1 as the rotational axis, the protrusion 94 coincides with itself three times. Hence, the outer peripheral surface of the protrusion 94 has the rotational symmetry with respect to the center C1 of the protrusion 94. In the present embodiment, when the protrusion 94 is rotated 360 degrees about the center C1 as the rotational axis, the protrusion 94 coincides with itself only once. Hence the outer peripheral surface of the protrusion 94 does not have a rotational symmetry with respect to the center C1. As a result, the protrusion 94 can be inserted into the through-hole 72 in only one direction. The center C1 is a point at which the central point of a line segment defining the length of the protrusion 94 in the left–right direction and the central point of a line segment defining the length of the protrusion 94 in the front–rear direction coincide with each other when viewed from above. In the present embodiment, the center C1 is a point at which a central point of a line segment L1 connecting the left outer flat surface 94B and the right outer flat surface 94C, and a central point of a line segment L2 connecting the front end of the outer curved surface 94A and the rear outer flat surface 94D coincide with each other. The outer curved surface 94A is an example of the first curved surface. The rear outer flat surface 94D is an example of the first flat surface.

The protrusion 94 includes an upper wall 97 positioned at the upper end portion of the protrusion 94. The upper wall 97 is positioned slightly downward relative to the upper end of the protrusion 94. The upper wall 97 has an upper surface orthogonal to the up-down direction. The upper wall 97 has a flat plate shape extending in the front-rear direction and the left-right direction. A recessed portion 98 is defined by the upper surface of the upper wall 97 and the inner peripheral surface of the protrusion 94. The inner peripheral surface of the recessed portion 98 is parallel to the outer peripheral surface of the protrusion 94.

The key member 99 extends rearward from the rear outer flat surface 94D of the outer peripheral surface of the protrusion 94. The position and shape of the key member 99 coincide with the position and shape of the key groove 74 of the corresponding through-hole 72 to which the corresponding liquid bottle 80 is connected. In other words, the four liquid bottles 80 respectively store inks of different colors from one another, the colors being selected from black, yellow, cyan, and magenta. In the four liquid bottles 80, the positions and shapes of the key members 99 relative to the respective rear outer flat surfaces 94D are different from one another. In FIG. 14, the key member 99 of the liquid bottle 80 which coincides with the leftmost through-hole 72 of the tank cover 110 is illustrated. The key member 99 is an example of the first rib.

An opening 95 and the bottle tube 96 are positioned at the upper surface of the upper wall 97 of the protrusion 94. The opening 95 is positioned further rearward than the center C1 of the protrusion 94. The opening 95 has a circular shape. The opening 95 provides a communication between the inner space of the liquid bottle 80 and the outside. The bottle tube 96 is positioned further frontward than the opening 95. The bottle tube 96 is positioned further frontward than the center C1 of the protrusion 94. The bottle tube 96 is a tube and the inner space of the bottle tube 96 provides a communication between the inner space of the liquid bottle 80 and the outside. The outer shape of the bottle tube 96 is a polygon which coincides with the shape of the communication port 119 of the ink tank 100. That is, the front portion of the outer shape of the bottle tube 96 has a circular shape, and the rear portion of the outer shape of the bottle tube 96 has a rectangular shape. In other words, the outer shape of the bottle tube 96 has a quadrilateral shape whose front portion convex outward in an arc shape. The opening 95 is an example of the second communication port. The bottle tube 96 is an example of the second nozzle. The opening 95 and the bottle tube 96 are examples of the connection port.

The annular rib 91 is positioned at the outer circumferential portion of the upper surface of the bottom wall 92. The annular rib 91 is spaced outward from the protrusion 94. The annular rib 91 protrudes upward from the upper surface of the bottom wall 92. The annular rib 91 extends annularly along the outer circumferential portion of the upper surface of the bottom wall 92. The annular rib 91 surrounds the outer peripheral surface of the protrusion 94. Accordingly, an ink holding space 121 defined by the inner peripheral surface of the annular rib 91, the outer peripheral surface of the protrusion 94, and the upper surface of the bottom wall 92. The annular rib 91 is an example of the third rib. Also, the annular rib 91 is an example of the first rib.

As illustrated in FIG. 16, the valve 161 is positioned in the inner space of the protrusion 94. The valve 161 includes a valve body 161A, a valve seat 161B, and a coil spring 161C. The valve body 161A is a flat plate shape extending in the front-rear direction and the left-right direction. The valve body 161A has a substantially oblong shape along the inner surface of the protrusion 94 when viewed in the up-down direction. Each of the opening 95 and the bottle tube 96 has an opening which opens to the inner space of the liquid bottle 80. The upper surface of the valve body 161A closes the openings of the opening 95 and the bottle tube 96.

The valve seat 161B is positioned further downward than the valve body 161A. The valve seat 161B has a flat plate shape extending in the front-rear direction and the left-right direction. The valve seat 161B is fixed to the inner surface of the protrusion 94. The coil spring 161C is positioned between the valve body 161A and the valve seat 161B. The coil spring 161C is configured to be compressed in the up-down direction. The lower end of the coil spring 161C is supported by the upper surface of the valve seat 161B. The upper end of the coil spring 161C urges the valve body 161A upward. Accordingly, the coil spring 161C maintains the upper surface of the valve body 161A in a state where the upper surface of the valve body 161A closes the opening 95 and the opening of the bottle tube 96.

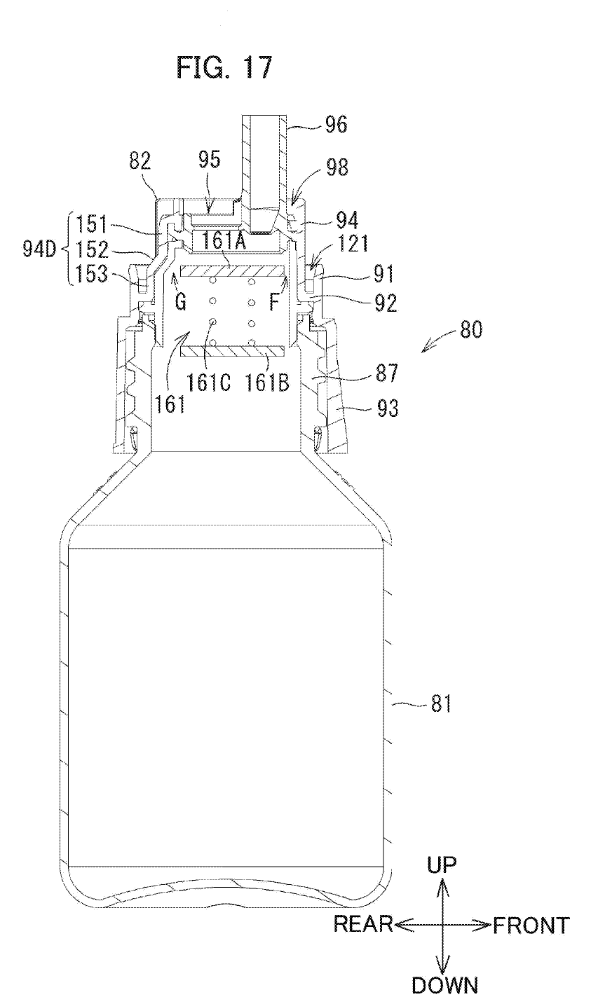

The valve 161 is movable between an opening position and a closed position in the up-down direction. As illustrated in FIG. 16, the closed position is a position at which the upper surface of the valve body 161A closes the opening 95 and the opening of the bottle tube 96. As illustrated in FIG. 17, the opening position is a position at which the valve body 161A is moved downward from the closed position against the urging force of the coil spring 161C.

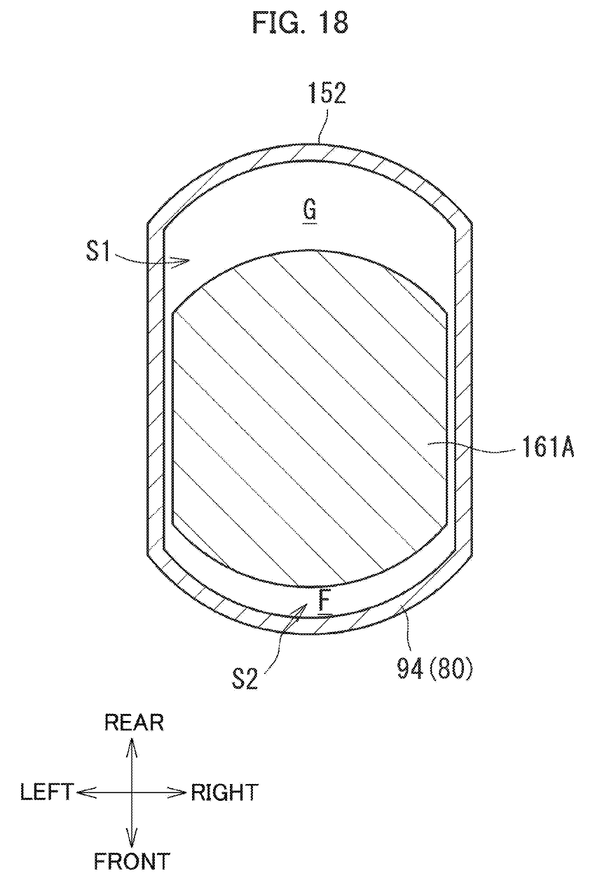

An air passage G and an ink passage F are defined between the inner surface of the liquid bottle 80 and the valve 161 which is at the opening position. The ink passage F is a passage through which ink flows. The ink passage F is defined by the inner surface of the liquid bottle 80 and the front end surface of the valve 161 which is at the opening position. The air passage G is a passage through which air flows. The air passage G is defined by the inner surface of the liquid bottle 80 and the rear end surface of the valve 161 which is at the opening position. The area of the air passage G is larger than the area of the ink passage F. Specifically, as illustrated in FIG. 18, in a cross-section of the liquid bottle 80 having the valve body 161A which is at the opening position taken along a horizontal plane, an area S1, which is surrounded by the inner surface of the liquid bottle 80 and the rear end surface of the valve body 161A, is larger than an area S2, which is surrounded by the inner surface of the liquid bottle 80 and the front end surface of the valve body 161A. The ink passage F is an example of the first passage. The air passage G is an example of the second passage.

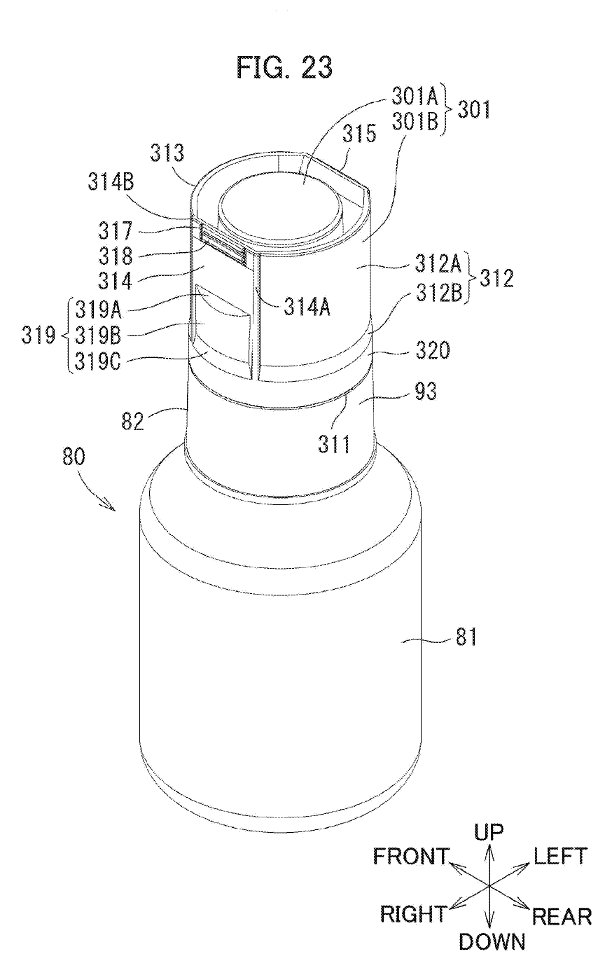

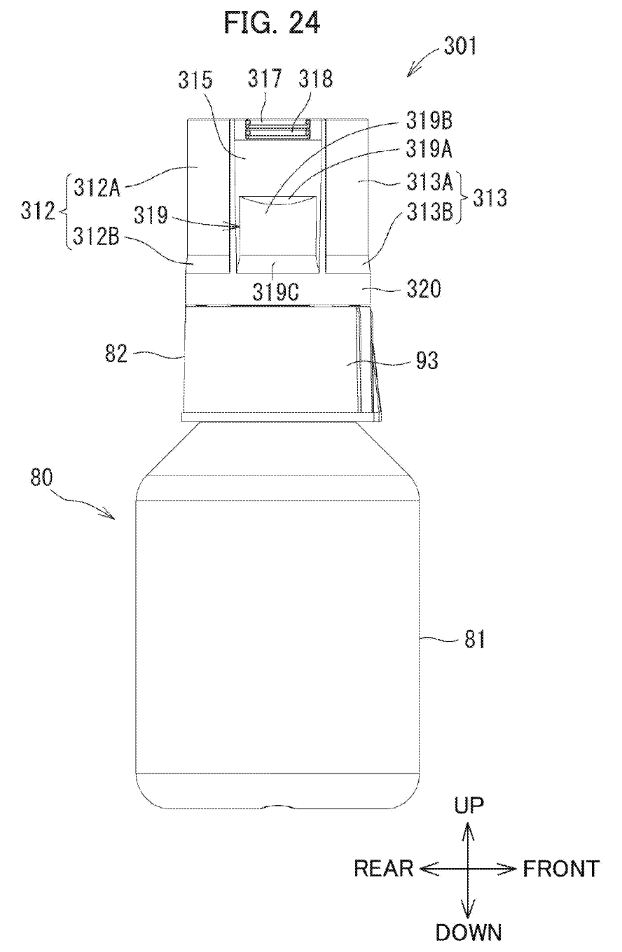

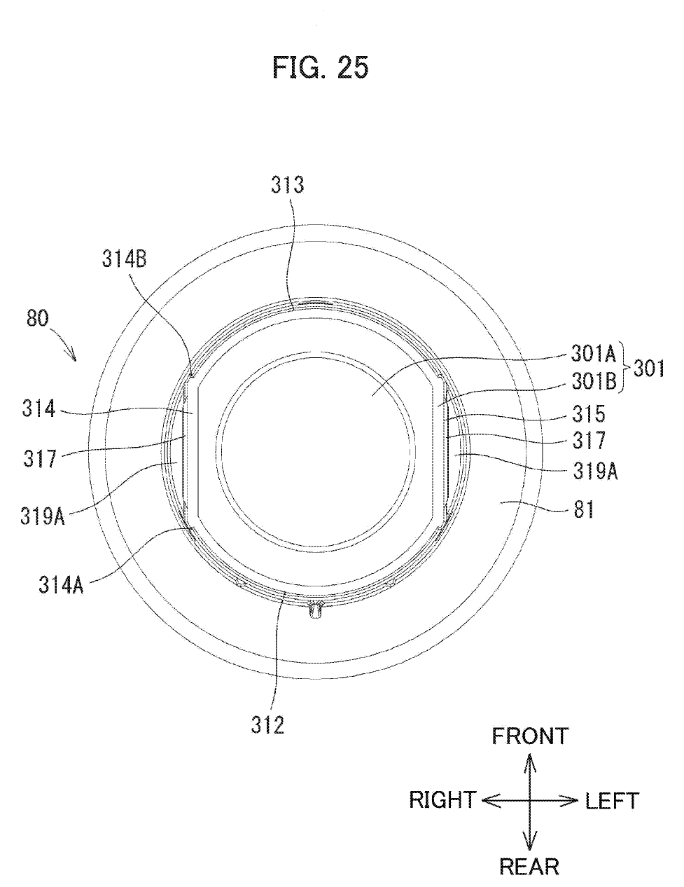

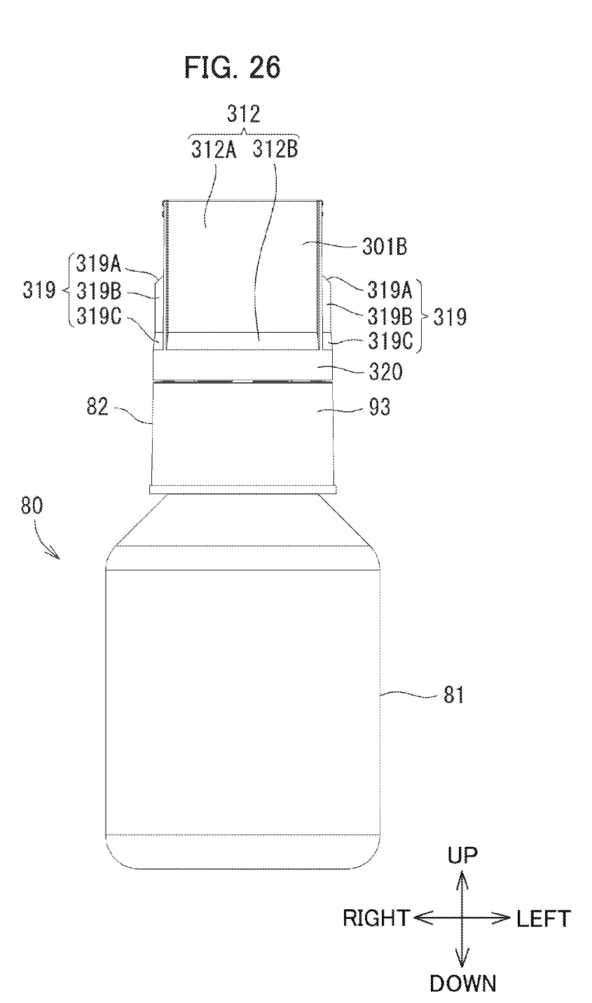

As illustrated in FIGS. 23 through 26, in a state where the liquid bottle 80 is not connected to the ink tank 100, a nozzle cap 301 is attached to the bottle cap 82. The nozzle cap 301 has an approximately cylindrical shape. The nozzle cap 301 is configured to cover the upper portion of the bottle cap 82 positioned further upward than the side wall 93. Specifically, the nozzle cap 301 has an inner cylinder 301A and an outer cylinder 301B.

The inner cylinder 301A has a cylindrical shape extending in the up-down direction. The upper end of the inner cylinder 301A is closed and the lower end of the inner cylinder 301A is open. The upper end surface of the inner cylinder 301A has a circular flat shape extending in the front-rear direction and the left-right direction. The upper end of the inner cylinder 301A is positioned slightly upward relative to the upper end of the bottle tube 96. The lower end of the inner cylinder 301A is inserted in the ink holding space 121, which has an annular shape. Hence, the inner cylinder 301A covers both the protrusion 94 and the bottle tube 96.

The outer cylinder 301B covers the outside of the inner cylinder 301A. The outer cylinder 301B has a cylindrical shape extending in the up-down direction. The upper end of the outer cylinder 301B and the lower end of the outer cylinder 301B are open. The upper end of the outer cylinder 301B coincides with the upper end of the inner cylinder 301A in the up-down direction. The lower end of the outer cylinder 301B is positioned slightly upward relative to the upper end of the side wall 93. A part of a triangle mark 311 positioned at the upper end of the side wall 93 is exposed through a slight gap between the lower end of the outer cylinder 301B and the upper end of the side wall 93 in the up-down direction. The outer cylinder 301B is connected to the inner cylinder 301A by an annular connection wall at a position slightly upward relative to the annular rib 91. The outer peripheral surface of the outer cylinder 301B has a rear outer curved surface 312, a front outer curved surface 313, a right outer flat surface 314, and a left outer flat surface 315.

The rear outer curved surface 312 is positioned at the rear portion of the outer peripheral surface of the outer cylinder 301B. The rear outer curved surface 312 extends downward from the upper end of the outer peripheral surface of the outer cylinder 301B. The lower end of the rear outer curved surface 312 is positioned further upward than the lower end of the outer cylinder 301B. The rear outer curved surface 312 has an arc shaped surface 312A and a sloped surface 312B. The arc shaped surface 312A is an arc shaped surface convex rearward. The sloped surface 312B is connected to the lower end of the arc shaped surface 312A. The sloped surface 312B is sloped relative to the arc shaped surface 312A such that the sloped surface 312B extends rearward as the sloped surface 312B extends downward.

The front outer curved surface 313 is positioned at the front portion of the outer peripheral surface of the outer cylinder 301B. The front outer curved surface 313 extends downward from the upper end of the outer peripheral surface of the outer cylinder 301B. The lower end of the front outer curved surface 313 is positioned further upward than the lower end of the outer cylinder 301B. The front outer curved surface 313 has an arc shaped surface 313A and a sloped surface 313B. The arc shaped surface 313A is an arc shaped surface convex frontward. The sloped surface 313B is connected to the lower end of the arc shaped surface 313A. The sloped surface 313B is sloped relative to the arc shaped surface 313A such that the sloped surface 313B extends frontward as the sloped surface 313B extends downward.

The right outer flat surface 314 is positioned at the right portion of the outer peripheral surface of the outer cylinder 301B. The right outer flat surface 314 extends downward from the upper end of the outer peripheral surface of the outer cylinder 301B. The lower end of the right outer flat surface 314 is positioned further upward than the lower end of the outer cylinder 301B. The right outer flat surface 314 is a flat surface extending in the up-down direction and the front-rear direction. The rear end of the right outer flat surface 314 protrudes further rightward than the right end of the rear outer curved surface 312. Hence, a rear rib 314A is positioned the rear end of the right outer flat surface 314. The rear rib 314A extends in the up-down direction. The front end of the right outer flat surface 314 protrudes further rightward than the right end of the front outer curved surface 313. Hence, a front rib 314B is positioned at the front end of the right outer flat surface 314. The front rib 314B extends in the up-down direction.

An upper protruding portion 317 and a lower protruding portion 318 are positioned at the upper end portion of the right outer flat surface 314. The upper protruding portion 317 and the lower protruding portion 318 protrude from the right outer flat surface 314 and extend linearly in the front-rear direction. The upper protruding portion 317 is positioned at the upper end of the right outer flat surface 314. The upper protruding portion 317 is positioned at the center of the right outer flat surface 314 in the front-rear direction. The length of the upper protruding portion 317 in the front-rear direction is shorter than the length of the right outer flat surface 314 in the front-rear direction. The lower protruding portion 318 is positioned slightly downward relative to the upper protruding portion 317 with a space. The lower protruding portion 318 is positioned at the center of the right outer flat surface 314 in the front-rear direction. The length of the lower protruding portion 318 in the front-rear direction is the same as the length of the upper protruding portion 317 in the front-rear direction.

A convex portion 319 is positioned at the right outer flat surface 314. The convex portion 319 is convex rightward in an approximately arc shape from the right outer flat surface 314. The convex portion 319 is positioned from the center of the right outer flat surface 314 in the up-down direction to the lower end of the right outer flat surface 314. Specifically, the convex portion 319 has an upper sloped surface 319A, an arc shaped surface 319B, and a lower sloped surface 319C. The upper sloped surface 319A is positioned at the upper end of the convex portion 319. The convex portion 319 has a D-shape when viewed from the above. The upper sloped surface 319A is sloped relative to the left-right direction such that the upper sloped surface 319A extends downward as the upper sloped surface 319A extends rightward. The upper sloped surface 319A is a flat surface extending in a direction in which the upper sloped surface 319A is sloped. The arc shaped surface 319B is an arc shaped surface which is convex rightward. The upper end of the arc shaped surface 319B is connected to the right end of the upper sloped surface 319A. The lower sloped surface 319C is connected to the lower end of the arc shaped surface 319B. The lower sloped surface 319C is sloped relative to the arc shaped surface 319B such that the lower sloped surface 319C extends rightward as the lower sloped surface 319C extends downward.

The left outer flat surface 315 is symmetrical with the right outer flat surface 314 in the left-right direction. That is, the members which are identical to the rear rib 314A, the front rib 314B, the upper protruding portion 317, the lower protruding portion 318, and the convex portion 319 are positioned at the left outer flat surface 315. Hence, the same explanation as the explanation of the right outer flat surface 314 is applied to the left outer flat surface 315.

A lower end portion 320 of the outer peripheral surface of the outer cylinder 301B has a cylindrical shape. That is, the portion of the outer peripheral surface of the outer cylinder 301B, which is positioned further downward than the rear outer curved surface 312, the front outer curved surface 313, the right outer flat surface 314, and the left outer flat surface 315 has a cylindrical shape.

The nozzle cap 301 configured as described above reduces the likelihood of leakage of ink from the opening 95 and the bottle tube 96 of the protrusion 94 to the outside of the liquid bottle 80.

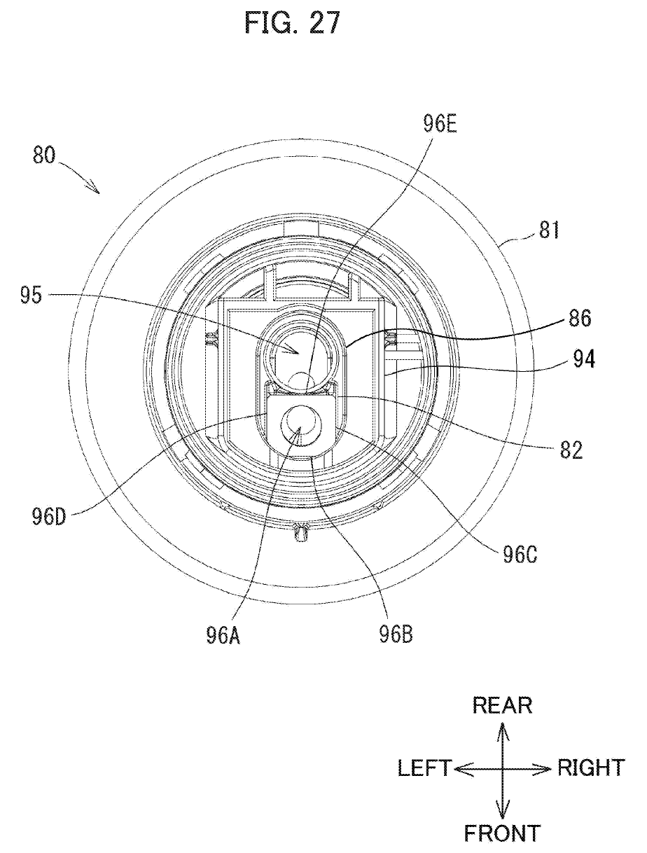

FIG. 27 is a plan view of the liquid bottle 80 in a state where the nozzle cap 301 is detached from the bottle cap 82. As illustrated in FIG. 27, a base portion 86 is positioned at the upper wall 97 of the protrusion 94. The base portion 86 protrudes upward from the upper surface of the upper wall 97 of the protrusion 94 and has an oblong shape extending in the front-rear direction. The opening 95, which has a circle shape, is positioned at the rear portion of the base portion 86. The opening 95 provides a communication between the inside and the outside of the liquid bottle 80. The bottle tube 96 is positioned at the front portion of the base portion 86. The bottle tube 96 is adjacent to the front portion of the opening 95. The bottle tube 96 has a passage 96A through which the inside and the outside of the liquid bottle 80 are communicated with each other. The passage 96A has a circle shape. The upper end of the bottle tube 96 is flat.

The outer peripheral surface of the bottle tube 96 has a quadrilateral shape whose front portion convex outward in an arc shape. Specifically, the outer peripheral surface of the bottle tube 96 has a front arc shaped surface 96B, a right outer flat surface 96C, a left outer flat surface 96D, and a rear outer flat surface 96E. The front arc shaped surface 96B has a shape which is convex frontward in an approximately arc shape. The right outer flat surface 96C is a flat surface extending in the up-down direction and the front-rear direction. The front end of the right outer flat surface 96C is connected to the right end of the front arc shaped surface 96B. The left outer flat surface 96D is a flat surface extending in the up-down direction and the front-rear direction. The right end of the left outer flat surface 96D is connected to the left end of the front arc shaped surface 96B. The rear outer flat surface 96E is a flat surface extending in the up-down direction and the left-right direction. The right end of the rear outer flat surface 96E is connected to the rear end of the right outer flat surface 96C. The left end of the rear outer flat surface 96E is connected to the rear end of the left outer flat surface 96D.

The thickness of the corner portion formed by the left outer flat surface 96D and the rear outer flat surface 96E is greater than the thickness between the front arc shaped surface 96B and the passage 96A. The thickness of the corner portion formed by the right outer flat surface 96C and the rear outer flat surface 96E is greater than the thickness between the front arc shaped surface 96B and the passage 96A.

### Connection Between the Liquid Bottle 80 and the Ink Tank 100

Firstly, a user identifies a direction in which the protrusion 94 is inserted into the leftmost through-hole 72 of the tank cover 110. At this time, since the outer curved surface 94A and the rear outer flat surface 94D are positioned such that the opening 95 and the bottle tube 96 are positioned between the outer curved surface 94A and the rear outer flat surface 94D in the front-rear direction, a user can identify easily the direction in which the protrusion 94 is inserted into the through-hole 72.

Then, the user inserts the protrusion 94 into the leftmost through-hole 72 of the tank cover 110. At this time, the key member 99 is inserted into the key groove 74 of the through-hole 72. In a case where the user mistakenly attempts to insert the protrusion 94 into the through-hole 72 which is the second from the left, the key member 99 cannot be inserted into the key groove 74. As a result, the likelihood that the liquid bottle 80 is connected to an incorrect position is reduced. Upon the insertion of the key member 99 in the key groove 74, the bottle tube 96 is inserted in the corresponding communication port 119 of the ink tank 100 and the tank tube 115 is inserted in the corresponding opening 95 of the liquid bottle 80. At this time, the valve body 161A is pressed frontward and upward by the corresponding tank tube 115, and accordingly the valve body 161A is moved from the closed positioned toward the opening position against an urging force of the coil spring 161C. As a result, the liquid bottle 80 is connected to the ink tank 100. In this state: the bottle tube 96 is positioned further downward than the tank tube 115; the air passage G is positioned further upward than the ink passage F and the distal end of the tank tube 115. The outer curved surface 94A of the outer peripheral surface of the protrusion 94 is supported by the inner curved surface 72A of the inner peripheral surface of the corresponding through-hole 72.

In a state where the liquid bottle 80 is attached to the ink tank 100, ink stored in the liquid bottle 80 flows to the corresponding ink chamber 111 through the ink passage F and the inner space of the bottle tube 96. Simultaneously, air flows to the ink chamber 111 through the air communication port 112, and then air flows to the inside of the corresponding liquid bottle 80 through the tank tube 115. Air which flows to the inside of the liquid bottle 80 moves toward the upper portion of the inside of the liquid bottle 80 through the air passage G, which is positioned further upward than the distal end of the tank tube 115. As described above, so-called gas–liquid replacement occurs, and accordingly ink in the liquid bottle 80 is supplied to the corresponding ink chamber 111.

### Attachment of the Tank Cap 127 to Ink Tank Set 51

In a state where the liquid bottle 80 is not attached to the ink tank set 51, the tank cap 127 is attached to the ink tank set 51. A user holds the grip portion 133 of the tank cap 127 and the user holds the tank cap 127 in a posture in which the flat plate portion 132 is insertable into the slit 73 of the tank cover 110.

Then, the user inserts the flat plate portion 132 in the slit 73 of the tank cover 110. At the same time, the rubber 129 of the tank cap 127 is inserted in the circular-shaped wall 122 of the ink tank 100 through the through-hole 72 of the tank cover 110.

As illustrated in FIG. 12, since the flat plate portion 132 of the tank cap 127 is inserted in the slit 73 of the tank cover 110, the tank cap 127 is in the attached posture, in which the longitudinal direction of the opening 138 of the rubber 129 is along the front-rear direction and crosses the horizontal direction. In the attached posture, flanges 140 are positioned at the right portion and left portion of the opening 138 and no flanges 140 are disposed at the front portion and rear portion of the opening 138.

As illustrated in FIG. 13, in the attached posture, the tank tube 115 is in a state where the tank tube 115 is inserted in the tubular portion 130 of the tank cap 127 through the opening 138 of the rubber 129. There is a gap between the tank tube 115 and the inner peripheral surface 137 of the tubular portion 130 of the tank cap 127. As a result, the likelihood that ink adhered to the tank tube 115 due to the connection of the liquid bottle 80 to the ink chamber 111 transfers to the inner peripheral surface 137 of the tubular portion 130 is reduced.

However, in a case where ink droplets adhered to the outer surface of the tank tube 115 are relatively large, the ink droplets possibly fall from the tank tube 115 and are possibly adhered to the inner peripheral surface 137 of the tubular portion 130. The ink droplets adhered to the inner peripheral surface 137 of the tubular portion 130 moves downward along the inner peripheral surface 137 by gravity. Since the flange portion 140 is not positioned at the lower portion of the opening 138, the ink droplets adhered to the inner peripheral surface 137 of the tubular portion 130 can easily move to the inside of the circular-shaped wall 122 through the opening 138. The ink droplets which move to the inside of the circular-shaped wall 122 drop into the ink chamber 111 through the communication port 119. If the flange portion 140 is positioned at the lower portion of the opening 138, the movement of the ink droplets is blocked by the flange portion 140, and accordingly the ink droplets are less likely to move to the inside of the circular-shaped wall 122 through the opening 138.

In a process where the tank cap 127 reaches to the attached posture, the protruding portion 139 of the rubber 129 moves in sliding contact with the inner surface 123 of the circular-shaped wall 122. Since the contact portion 136 is in contact with the end surface of the opening of the tubular portion 130, the position of the rubber 129 is less likely to be moved relative to the tubular portion 130. The protruding portion 139 of the rubber 129 is configured to be in liquid-tight contact with the inner surface 123 of the circular-shaped wall 122. As a result, the likelihood of the leakage of ink stored in the ink chamber 111 to the outside of the ink tank 100 through the tank tube 115 and the communication port 119 can be reduced.

### Technical Effects of This Embodiment

The outer peripheral surface of the protrusion 94 has a shape, which corresponds to the shape of the inner peripheral surface of the corresponding through-hole 72 of the tank cover 110. That is, the shape of the outer peripheral surface of the protrusion 94 in the axial direction corresponds to the shape of the corresponding through-hole 72. Also, the outer peripheral surface of the protrusion 94 is not rotationally symmetrical about the center C1 of the protrusion 94. That is, the insertion of the protrusion 94 into the through-hole 72 is allowed in only one direction. Accordingly, a user can easily connect the liquid bottle 80 and the ink tank 100 to each other, regardless of the positions of the opening 95 and the bottle tube 96 in the liquid bottle 80 and the positions of the tank tube 115 and the communication port 119 in the ink tank 100. As a result, high flexibility can be obtained in designing the liquid bottle 80 and the ink tank 100.

The outer peripheral surface of the protrusion 94 has the outer curved surface 94A, which is convex frontward, and the rear outer flat surface 94D, between which the opening 95 and the bottle tube 96 are positioned in the front-rear direction. As a result, a user can easily identify the direction in which the protrusion 94 can be inserted in the corresponding through-hole 72.

The outer curved surface 94A and the rear outer flat surface 94D of the outer peripheral surface of the protrusion 94 are emphasized by the recessed portion 98. As a result, a user can easily identify the direction in which the protrusion 94 can be inserted in the corresponding through-hole 72.

The liquid bottle 80 includes the key member 99, which extends rearward from the rear outer flat surface 94D of the outer peripheral surface of the protrusion 94. As a result, a user can easily identify the direction in which the protrusion 94 can be inserted in the corresponding through-hole 72.

In a state where the liquid bottle 80 is not attached to the ink tank 100, the likelihood of the leakage of ink from the inside of the liquid bottle 80 to the outside of the liquid bottle 80 through the bottle tube 96 and the opening 95 is reduced by the valve 161.

A user can move the valve 161 from the closed positioned to the opening position by the insertion of the tank tube 115 in the opening 95 of the liquid bottle 80. As a result, a user can promptly connect the liquid bottle 80 to the ink tank 100.

The tank tube 115 is configured to be inserted in the opening 95. The bottle tube 96 is configured to be inserted in the communication port 119 of the ink tank 100. Hence, ink stored in the liquid bottle 80 flows in the ink chamber 111 of the ink tank 100 through the bottle tube 96 and the communication port 119, which are connected to each other. On the other hand, air in the ink chamber 111 of the ink tank 100 flows to the inside of the liquid bottle 80 through the tank tube 115 and the opening 95, which are connected to each other. That is, the passage, through which ink flows from the inside of the liquid bottle 80 to the inside of the ink tank 100, and the passage, through which air flows from the inside of the ink tank 100 to the inside of the liquid bottle 80, are separated by the bottle tube 96 and the tank tube 115. Accordingly, gas–liquid exchange of ink and air can be performed smoothly between the liquid bottle 80 and the ink tank 100. As a result, ink stored in the liquid bottle 80 can be promptly supplied to the ink tank 100.

In a connected posture where the liquid bottle 80 is connected to the ink tank 100, the bottle tube 96 is positioned further downward than the tank tube 115. Accordingly, ink, which has a greater weight than air, moves through the bottle tube 96. On the other hand, air, which has a smaller weight than ink, moves through the tank tubes 115, which is positioned further upward than the bottle tube 96. As a result, the passage, through which ink flows from the inside of the liquid bottle 80 to the inside of the ink tank 100, and the passage, through which air flows from the inside of the ink tank 100 to the inside of the liquid bottle 80, can be reliably separated.

The area S1 of the air passage G is greater than the area S2 of the ink passage F. Further, in a state where the liquid bottle 80 is connected to the ink tank 100, the air passage G is positioned further upward than the ink passage F. Accordingly, air, which has a smaller weight than ink and flows from the inside of the ink tank 100 in the inside of the liquid bottle 80 through the tank tube 115, passes through the air passage G. On the other hand, ink in the liquid bottle 80, which has a greater weight than air, passes through the ink passage F positioned further downward than the air passage G. Accordingly, the passage of air and the passage of ink are separated. As a result, gas–liquid exchange of ink and air can be performed smoothly between the liquid bottle 80 and the ink tank 100.

When the liquid bottle 80 is inserted in the ink tank 100, the tank tube 115 is inserted in the opening 95, which is positioned further rearward than the center C1 of the protrusion 94. Hence, the distal edge of the tank tube 115 presses the portion of the valve body 161A positioned apart from the center of the valve body 161A. In this case, the valve body 161A is possibly tilt. However, in the multifunction peripheral 10, the distal end of the tank tube 115 is divided in the left-right direction into two lip portions. Accordingly, in the case where the distal edge of the tank tube 115 presses the portion of the valve body 161A positioned apart from the center of the valve body 161A, a moment of force is less likely to act on the valve body 161A. As a result, the likelihood of tilting of the valve body 161A is reduced. Also, a gap to which air can flow is secured at the distal end of the tank tube 115. As a result, air in the ink tank 100 can smoothly move to the inside of the liquid bottle 80 through the tank tube 115.

The bottle tube 96 has a polygonal outer shape. The opening 95 has a circular shape. Accordingly, the outer shape of the bottle tube 96 and the shape of the opening 95 are clearly different from each other. As a result, a user can easily recognize that there is the direction, in which the protrusion 94 can be inserted in the corresponding through-hole 72.

In the connected posture where the liquid bottle 80 is connected to the ink tank 100, the outer curved surface 94A of the outer peripheral surface of the protrusion 94 is supported by the inner curved surface 72A of the inner circumferential surface of the corresponding through-hole 72. As a result, the liquid bottle 80 can be maintained in the connected posture.

When the liquid bottle 80 is detached from the ink tank set 51, there is a possibility that ink leaks from the opening of the distal end of the bottle tube 96. In the multifunction peripheral 10, ink leaked from the distal end of the bottle tube 96 move frontward and downward along the sloped surface 104A, and then are blocked by the weir wall 109. Ink blocked by the weir wall 109 pools in the weir wall 109, and then flows in the left-right direction along the weir wall 109. As a result, the likelihood that the front surface of the ink tank 100 is contaminated with ink can be reduced.

In the multifunction peripheral 10, for example, in a case where the design of the protrusions 94 of the liquid bottles 80 are changed, only the design of the tank cover 110 having the through-holes 72, in which the protrusions 94 can be inserted, needs to be changed. As a result, the design change is easier than a case where the design of the entire ink tank set 51 is changed.

In the four through-holes 72 of the tank cover 110, the positions and shapes of the key grooves 74 relative to the respective rear inner flat surfaces 72D are different from one another. The key member 99 of the protrusion 94 of the liquid bottle 80 illustrated in FIG. 14 is configured to be inserted in only the key groove 74 of the leftmost through-hole 72. The likelihood that a user incorrectly inserts the protrusion 94 of the liquid bottle 80 in the through-hole 72 corresponding to the ink chamber 111 storing ink whose color is different from the color of ink stored in the liquid bottle 80 can be reduced.

In a state where the tank cap 127 is attached to the circular-shaped wall 122, the protruding portion 139 is in liquid-tight contact with the inner peripheral surface of the circular-shaped wall 122. As a result, the likelihood that ink in the ink chamber 111 leaks to the outside through a gap between the outer surface of the rubber 129 and the inner peripheral surface of the circular-shaped wall 122 can be reduced. Further, the likelihood that contaminants enter in the ink chamber 111 through the gap between the outer surface of the rubber 129 and the inner peripheral surface of the circular-shaped wall 122 can be reduced. The tank cap 127 includes the grip portion 133. The grip portion 133 has a semicircular plate shape that protrudes upward from the outer surfaces of the tubular portion 130 and flat plate portion 132 in a state where the tank cap 127 is inserted in the through-hole 72. As a result, a user can easily identify the direction in which the tank cap 127 can be inserted in the corresponding through-hole 72.

The weight of the grip portion 133 is heavier than the total weight of the main body 128 and the rubber 129. Hence, when the one of the pair of the protruding pieces 131 is in contact with the floor, the grip portion 133 is in contact with the floor. Accordingly, the portion of the tank cap 127 on the rubber 129 side relative to the protruding pieces 131 is raised from the floor. As a result, in a state where the tank cap 127 is placed on the floor, the likelihood that ink adheres to the floor can be reduced.

When the bottle tube 96 is pulled out from the corresponding communication port 119 of the ink tank 100, there is a possibility that ink leaks downward from the opening of the distal end of the bottle tube 96 along the outer peripheral surface of the protrusion 94. However, the ink is held by the ink holding space 121, which is defined by the inner peripheral surface of the annular rib 91, the outer peripheral surface of protrusion 94, and the upper surface of the bottom wall 92. As a result, even though ink leaks from the opening of the distal end of the bottle tube 96, the likelihood that the liquid bottle 80 is contaminated with the ink can be reduced.

The four liquid bottles 80 respectively store inks of different colors from one another, the colors being selected from black, yellow, cyan, and magenta. In the liquid bottles 80, the positions and shapes of the key members 99 relative to the respective rear outer flat surfaces 94D are different from one another. As a result, the likelihood that a user incorrectly inserts the protrusion 94 of the liquid bottle 80 in the through-hole 72 corresponding to the ink chamber 111 storing ink whose color is different from the color of ink stored in the liquid bottle 80 can be reduced.

### Variations

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

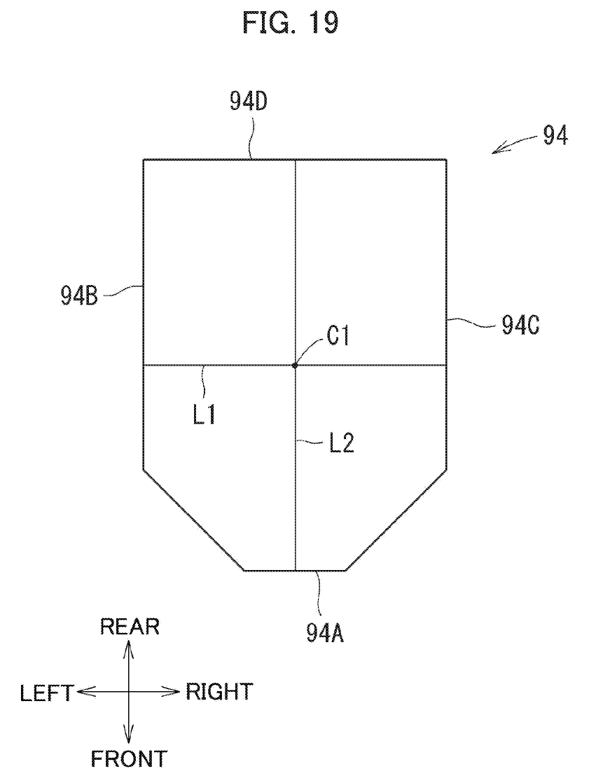

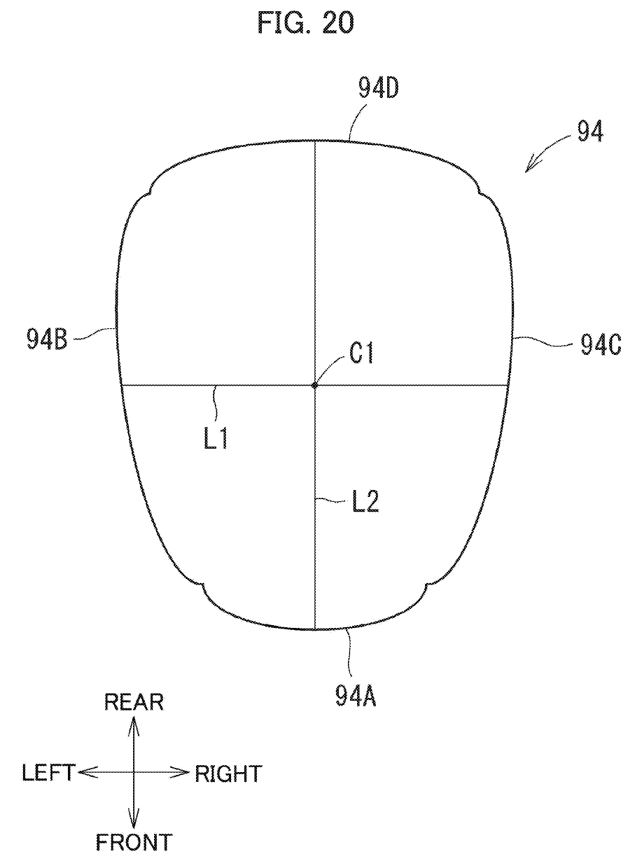

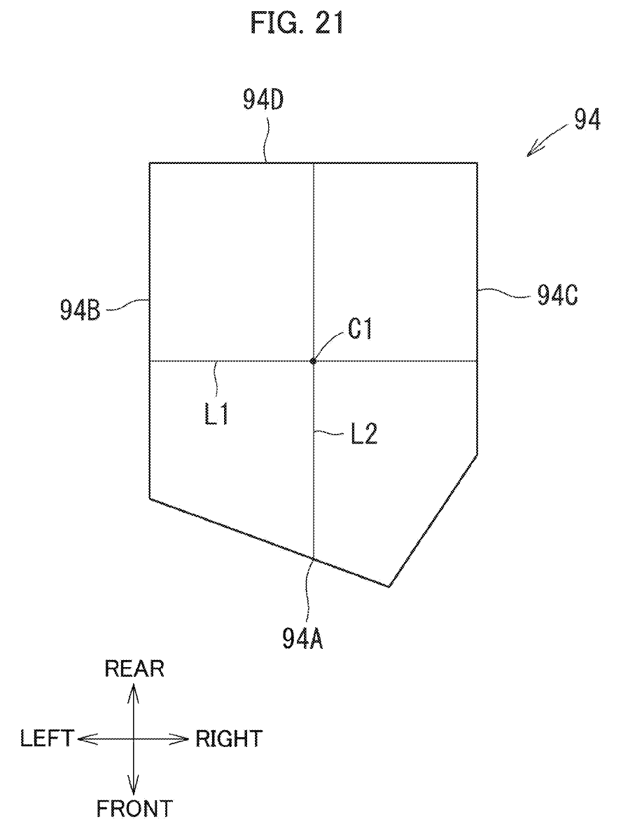

In the embodiment described above, the outer peripheral surface of the protrusion 94 has a quadrilateral shape whose front portion convex outward in an arc shape. However, the outer peripheral surface of the protrusion 94 may have any shape as long as the protrusion 94 is not rotationally symmetrical about the center C1 of the protrusion 94. For example, as illustrated in FIG. 19, the outer curved surface 94A may include three flat surface. Further, as illustrated in FIG. 20, the left outer flat surface 94B may be a curved surface convex leftward, the right outer flat surface 94C may be a curved surface convex rightward, and the rear outer flat surface 94D may be a curved surface convex rearward. In this case, the left outer flat surface 94B is the curved surface such that its rear end is positioned further leftward than its front end, and the right outer flat surface 94C is the curved surface such that its rear end is positioned further rightward than its front end. Further, the outer peripheral surface of the protrusion 94 may have a polygonal shape in which the lengths of the respective sides are different from each other. For example, as illustrated in FIG. 21, the outer peripheral surface of the protrusion 94 has the outer curved surface 94A formed by two flat surfaces, the left outer flat surface 94B, the right outer flat surface 94C, and the rear outer flat surface 94D. The lengths of the line segments of each the two flat surfaces of the outer curved surface 94A, the left outer flat surface 94B, the right outer flat surface 94C, and the rear outer flat surface 94D may be different from one another. Also, the inner peripheral surface of the through-hole 72 of the ink tank set 51 may have any shape as long as the shape is not rotationally symmetrical about the center of the through-hole 72 and corresponds to the shape of the outer peripheral surface of the protrusion 94 of the liquid bottle 80, which is configured to be inserted in the through-hole 72.

In the embodiment described above, the outer curved surface 94A and the rear outer flat surface 94D of the outer peripheral surface of the protrusion 94 are positioned such that the opening 95 and the bottle tube 96 are positioned between the outer curved surface 94A and the rear outer flat surface 94D in the front-rear direction. However, the outer curved surface 94A and the rear outer flat surface 94D of the outer peripheral surface of the protrusion 94 may be positioned such that the opening 95 and the bottle tube 96 are positioned between the outer curved surface 94A and the rear outer flat surface 94D in the left-right direction, for example.

In the embodiment described above, the recessed portion 98 is defined by the upper surface of the upper wall 97 of the protrusion 94 and the inner peripheral surface of the protrusion 94. However, the recessed portion 98 may be omitted. In this case, the upper wall 97 of the protrusion 94 may be positioned at the upper end of the protrusion 94.

In the embodiment described above, the key member 99 is positioned at the rear outer flat surface 94D of the protrusion 94. However, the key member 99 may be positioned at the right outer flat surface 94C of the protrusion 94, for example. In this case, the key groove 74, in which the corresponding key member 99 can be inserted, is positioned at the right inner flat surface 72C of the through-hole 72. Also, the key member 99 may be omitted.

In the embodiment described above, the valve 161, which is configured to close the opening 95 and the opening of the bottle tube 96 which is positioned in the inner space of the liquid bottle 80, is disposed. However, the valve 161 may be omitted.

In the embodiment described above, since the distal end of the tank tube 115, which is inserted in the corresponding opening 95, presses the valve 161, the valve 161 is moved from the closed position to the opening position. However, the valve 161 may be moved from the closed position to the opening position by a user’s operation after the insertion of the tank tube 115 in the opening 95. In this case, the distal end of the tank tube 115 is not necessarily inserted in the opening 95.

In the embodiment described above, since the bottle tube 96 is inserted in the corresponding communication port 119, the connection between the bottle tube 96 and the communication port 119 is completed. However, the bottle tube 96 is not necessarily inserted in the communication port 119 as long as ink stored in the liquid bottle 80 can flow in the ink chamber 111 through the bottle tube 96 and the communication port 119. For example, the distal end of the bottle tube 96 may be positioned near the corresponding communication port 119.

In the embodiment described above, the liquid bottle 80 includes the bottle tube 96 and the opening 95 as connection port, and the ink tank 100 includes the tank tube 115 and the communication port 119 as connection receiving port. However, this configuration is not limited as long as ink can be supplied from the liquid bottle 80 to the ink tank 100. For example, the bottle tube 96 and the tank tube 115 may be omitted. In this case, after the insertion of the protrusion 94 of the liquid bottle 80 in the corresponding through-hole 72 of the tank cover 110, the valve 161 is moved from the closed position to the opening position by a user. Accordingly, ink stored in the liquid bottle 80 flows into the ink chamber 111 through the opening 95 and the communication port 119. Also, the tank tube 115 and the opening 95 may be omitted, for example. In this case, the valve 161 is omitted. Since the bottle tube 96 is inserted in the communication port 119, ink stored in the liquid bottle 80 flows into the ink chamber 111 through the bottle tube 96. In this case, it is preferable that the bottle tube 96 has a passage through which ink flows and a passage through which air flows. Also, the bottle tube 96 and the communication port 119 may be omitted, for example. In this case, since the tank tubes 115 is inserted in the opening 95, the valve 161 is moved from the closed position to the opening position. Accordingly, ink stored in the liquid bottle 80 flows into the ink chamber 111 through the tank tube 115. In this case, it is preferable that the tank tubes 115 has a passage through which ink flows and a passage through which air flows.

In the embodiment described above, the tank tube 115 protrudes frontward and upward beyond the upper surface of the upper wall 104 of the ink tank 100. However, the tank tube 115 may protrude upward beyond the upper surface of the upper wall 104, for example. In this case, in a state where the liquid bottle 80 is connected to the ink tank 100, the tank tube 115 and the bottle tube 96 are arranged in the front-rear direction and the air passage G and the ink passage F are also arranged in the front-rear direction.

In the embodiment described above, the area of the air passage G is larger than the area of the ink passage F. However, the area of the air passage G may equal to the area of the ink passage F, for example.

In the embodiment described above, the distal end of the tank tube 115 is divided in the left-right direction into two lip portions. However, the configuration is not limited as long as the distal end of the tank tube 115 has a shape which can press the valve 161. For example, the distal end of the tank tube 115 may have a shape such that the inner space of the tank tube 115 opens only upward. Also, the distal end of the tank tube 115 may have a cylindrical shape.

In the embodiment described above, the bottle tube 96 has a polygonal outer shape and the opening 95 has a circular shape. However, both the outer shape of the bottle tube 96 and the opening 95 may have a circular shape. Also, both the outer shape of the bottle tube 96 and the opening 95 may have a polygonal shape.

In the embodiment described above, the inner surface of the through-hole 72 has a cylindrical shape extending frontward and upward. However, the inner surface of the through-hole 72 may have a cylindrical shape extending upward. In this case, the inner curved surface 72A is positioned at the front portion of the inner peripheral surface of the through-hole 72.

In the embodiment described above, the upper wall 104 of the ink tank 100 has the sloped surface 104A, which slops relative to the front-rear direction such that the sloped surface 104A extends downward as the sloped surface 104A extends frontward. However, the sloped surface 104A may slop relative to the front-rear direction such that the sloped surface 104A extends upward as the sloped surface 104A extends frontward.

In the embodiment described above, the weir wall 109, which protrudes frontward and upward from the sloped surface 104A, is disposed. However, the shape of the weir wall 109 is not limited as long as ink flowing along the upper wall 104 can be blocked. Also, the weir wall 109 may be omitted.

In the embodiment described above, the ink tank set 51 includes the tank cover 110, which holds the ink tank 100 while the tank cover 110 covers the front portion of the ink tank 100 from the front. However, the ink tank set 51 does not necessarily include the tank cover 110. In this case, the four through-holes 72 are formed at the ink tank 100 such that the each through-hole 72 corresponds to the respective one of the four ink chambers 111. Specifically, cylindrical hole portions are formed at the upper surface of the upper wall 104 of the ink tank 100. The through holes have a cylindrical shape and extend frontward and upward from the front end portion of the upper surface of the upper wall 104. Each through-hole surrounds the corresponding circular-shaped wall 122.

In the embodiment described above, the positions of the key grooves 74 relative to the respective inner curved surfaces 72A are different from one another in the through-holes. However, the positions of the key grooves 74 relative to the respective inner curved surfaces 72A may be the same. Also, the key groove 74 may be omitted. In a case where the key groove 74 are omitted, the key member 99 are also omitted.

In the embodiment described above, in the attached posture, where the tank cap 127 is attached to the circular-shaped wall 122, the grip portion 133 of the tank cap 127 has a slender shape in the left-right direction. However, the grip portion 133 of the tank cap 127 may have a slender shape in the front-rear direction. Also, the tank cap 127 may be omitted.

In the embodiment described above, the weight of the grip portion 133 is heavier than the total weight of the main body 128 and the rubber 129. However, the weight of the grip portion 133 may be equal to or smaller than the total weight of the main body 128 and the rubber 129.

In the embodiment described above, the annular rib 91, which protrudes upward from the upper surface of the bottom wall 92, is disposed. However, the annular rib 91 may be omitted.

In the embodiment described above, the positions of the key members 99 relative to the rear outer flat surfaces 94D of the respective liquid bottles 80, which store the respective one of black, yellow, cyan, magenta, are different from one another. However, the positions of the key members 99 relative to the rear outer flat surfaces 94D of the respective liquid bottles 80 may be the same. The key member 99 may be omitted. In a case where the key member 99 is omitted, the key groove 74 may be omitted.

In the embodiment described above, the ink tank 100 includes the four ink chambers 111 respectively storing inks of different colors from one another. The ink tank 100 is molded as a single piece. However, the ink tank 100 may be composed of a tank including the ink chamber 111 storing black ink, a tank including the ink chamber 111 storing yellow ink, a tank including the ink chamber 111 storing cyan ink, and a tank including the ink chamber 111 storing magenta ink which are molded separately.

In the embodiment described above, the protruding portion 139 of the rubber 129 of the tank cap 127 is configured to be in liquid-tight contact with the inner surface 123 of the circular-shaped wall 122. However, the protruding portion 139 may be configured to be in liquid-tight contact with the end surface of the circular-shaped wall 122.

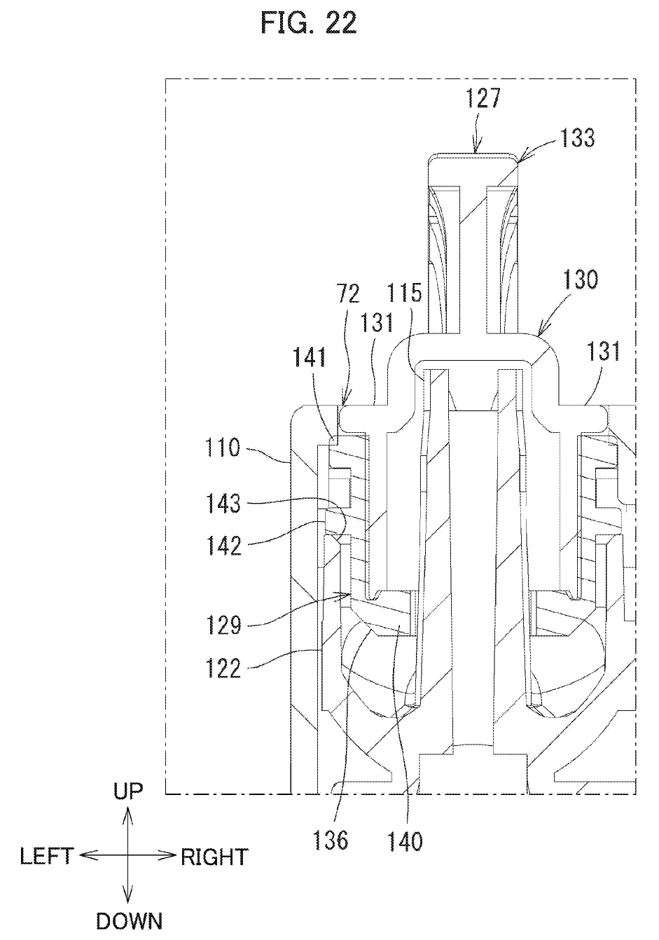

As illustrated in FIG. 22, the rubber 129 of the tank cap 127 has protruding portions 141 and 142 protruding annularly from the outer peripheral surface of the rubber 129 of the tank cap 127. The protruding portion 141 is positioned further upward than the protruding portion 142. That is, the protruding portions 141 and 142 are positioned apart from each other in the up-down direction. The outer diameter of the protruding portion 141 is larger than the outer shape of the through-hole 72. The outer diameter of the protruding portion 142 is larger than the outer diameter of the end surface 143 of the circular-shaped wall 122 of the ink tank 100.

When the rubber 129 of the tank cap 127 is inserted in the circular-shaped wall 122 of the ink tank 100 through the through-hole 72 of the ink tank 100, the protruding portion 142 of the rubber 129 comes in contact with an end surface 143 of the circular-shaped wall 122 through the through-hole 72 of the tank cover 110. The protruding portion 141 of the rubber 129 comes in contact with a back surface 144 of the tank cover 110 through the through-hole 72 of the tank cover 110. Since the protruding portion 141 contacts the back surface 144 of the tank cover 110, the protruding portion 142 is pressed against the end surface 143 of the circular-shaped wall 122. Accordingly, the protruding portion 142 is in liquid-tight contact with the end surface 143.

When the protruding portions 141 and 142 of the rubber 129 pass through the through-hole 72 of the tank cover 110, there is a possibility that a force is applied to the rubber 129. In this case, since the contact portion 136 of the rubber 129 is in contact with the end surface of the opening of the tubular portion 130, the rubber 129 is not displaced relative to the outer peripheral surface of the tubular portion 130.

In the embodiment described above, the flange portions 140 extends from both the left end and right end of the contact portion 136. However, the flange portion 140 may be positioned at only one of the left end and right end of the contact portion 136.

In the embodiment described above, each communication port 119 of the ink tank 100 and each through-hole 72 of the tank cover 110 have a quadrilateral shape whose front portion convex outward in an arc shape. However, the outer shapes each communication port 119 of the ink tank 100 and each through-hole 72 of the tank cover 110 are not limited. For example, each communication port 119 of the ink tank 100 and each through-hole 72 of the tank cover 110 may have a circular shape. Also, each communication port 119 of the ink tank 100 and each through-hole 72 of the tank cover 110 may have a quadrilateral shape.

Both the tank tube 115 and the communication port 119 are positioned inside the circular-shaped wall 122 of the ink tank 100. However, only one of the tank tube 115 and the communication port 119 may be positioned inside the circular-shaped wall 122 of the ink tank 100. Further, the two tank tubes 115 may be positioned inside the circular-shaped wall 122 of the ink tank 100. Further, the two communication ports 119 may be positioned inside the circular-shaped wall 122 of the ink tank 100. Further, the tank tube 115 extends diagonally upward. However, the tank tube 115 may extend in the up-down direction. The communication port 119 may face upward. Further, the circular-shaped wall 122 extends diagonally upward. However, the circular-shaped wall 122 may extend upward.

Further, the key grooves 74 of the tank cover 110 may be omitted. Further, the tank cap 127 may be in connection with the ink tank 100 or the tank cover 110. That is, the ink tank set 51 may include a holding member which is composed of members including an arm. The holding member is configured to hold the tank cap 127 which is detached from the circular-shaped wall 122 such that the tank cap 127 is in connection with the ink tank 100 or the tank cover 110. Further, in the tank cap 127, the grip portion 133 may be omitted. Further, in the tank cap 127, the grip portion 133 may have any shapes.

What is claimed is:

1. A system comprising:
a liquid bottle having a connection port, the liquid bottle being configured to store recording liquid;
a tank having a connection receiving port configured to be connected to the connection port, the tank being configured to store the recording liquid supplied from the liquid bottle through the connection port; and
a hole surrounding the connection receiving port, the hole having a cylindrical shape,
wherein the liquid bottle has a protrusion having the connection port, the protrusion being configured to be inserted in the hole, and
wherein a shape of an outer peripheral surface of the protrusion in an axial direction in which a center axis of the protrusion extends corresponds to a shape of the hole, the shape of the outer peripheral surface of the protrusion in the axial direction being not rotationally symmetrical about a center of the protrusion.

2. The system according to claim 1,
wherein the outer peripheral surface of the protrusion has:
a first curved surface convex outward; and
a first flat surface, and
wherein the first flat surface is positioned such that the connection port is positioned between the first curved surface and the first flat surface.

3. The system according to claim 2,
wherein the protrusion has one end and an other end opposite the one end in an extending direction in which the protrusion extends,
wherein the protrusion has a recess portion recessed from the one end toward the other end, and
wherein the recess portion has an inner peripheral surface parallel to the outer peripheral surface of the protrusion.

4. The system according to claim 3,
wherein the liquid bottle includes a first rib extending from the first flat surface in a direction orthogonal to the first flat surface.

5. The system according to claim 2,
wherein the liquid bottle includes a valve, the valve being positioned inside the liquid bottle, and
wherein the valve being movable between a closed position in which the valve closes the connection port and an opening position apart from the closed position.

6. The system according to claim 5,
wherein the connection receiving port has a first nozzle protruding beyond an outer surface of the tank, the first nozzle providing a communication between an inside of the tank and an outside of the tank, and
wherein the valve moves from the closed position to the opening position by being pressed by the first nozzle connected to the connection port.

7. The system according to claim 6,
wherein the connection receiving port has a first communication port, the first communication port providing a communication between the inside of the tank and the outside of the tank,
wherein the connection port has:
a second nozzle protruding from an outer surface of the protrusion, the second nozzle providing a communication between an inside of the liquid bottle and an outside of the liquid bottle; and
a second communication port providing a communication between the inside of the liquid bottle and the outside of the liquid bottle,
wherein, in a connected posture in which the protrusion is inserted in an inner space of the hole:
the first nozzle is connected to the second communication port; and
the second nozzle is connected to the first communication port,
wherein the valve is configured to open and close the second nozzle and the second communication port, and
wherein the valve moves from the closed position to the opening position by being pressed by the first nozzle connected to the second communication port.

8. The system according to claim 7,
wherein the first nozzle protrudes frontward and upward beyond the outer surface of the tank, and
wherein, in the connected posture, the second nozzle is positioned further downward than the first nozzle.

9. The system according to claim 8,
wherein a first passage and a second passage are defined between the valve positioned at the opening position and an inner surface of the liquid bottle, the first passage and the second passage allowing fluid to flow through the first passage and the second passage, and
wherein, in the connected posture, the second passage is positioned further upward than the first passage, and
wherein the second passage has an area larger than an area of the first passage.

10. The system according to claim 9,
wherein a distal end of the first nozzle is divided in a left-right direction into two lip portions, the left-right direction being orthogonal to an up-down direction and a front-rear direction.

11. The system according to claim 10,
wherein the second nozzle has a polygonal outer shape, and
wherein the second communication port has a circular shape.

12. The system according to claim 8,
wherein the hole extends frontward and upward,
wherein an inner peripheral surface of the hole has:
a second curved surface corresponding to the first curved surface; and
a second flat surface corresponding to the first flat surface, and
wherein the second curved surface is positioned at a lower portion of the hole.

13. The system according to claim 1,
wherein an outer surface of the tank has a sloped surface sloped relative to a front-rear direction such that the sloped surface extends downward as the sloped surface extends frontward,
wherein the connection receiving port has a first communication port providing a communication between an inside of the tank and an outside of the tank,
wherein the first communication port is positioned at the sloped surface,
wherein the tank has a first rib positioned further frontward than the first communication port, which is positioned at the sloped surface, and
wherein the first rib protrudes upward from the sloped surface and extends in a left-right direction which is orthogonal to an up-down direction and the front-rear direction.

14. The system according to claim 4,
wherein the tank includes a plurality of storage chambers configured to store recording liquid,
wherein the hole is provided for each of the storage chambers,
wherein each hole has a key groove positioned at the inner peripheral surface of the hole,
the system comprising the liquid bottle for each of the storage chambers,
wherein the first rib of each of the liquid bottles is configured to be inserted in the corresponding key groove, and
wherein the positions of the key grooves relative to the inner peripheral surfaces of the respective holes are different from one another.

15. The system according to claim 8, further comprising:
a cap attachable to a cylindrical wall of the tank, the cylindrical wall protruding from the outer surface of the tank, the cylindrical wall surrounding the first communication port and the first nozzle,
wherein the cap has:
a cap main body having a cylindrical shape, the cap main body being configured to be inserted in an inner space of the cylindrical wall, the cap main body being configured to cover an upper portion of the first communication port and an upper portion of the first nozzle; and
a grip portion having a semicircular plate shape, the grip portion protruding upward from an outer surface of the cap main body in a state where the cap main body is inserted in the inner space of the cylindrical wall, and
wherein the outer surface of the cap main body has a shape such that the outer surface of the cap main body makes into liquid-tight contact with an inner peripheral surface of the cylindrical wall.

16. The system according to claim 15,
wherein the grip portion has a weight greater than a weight of the cap main body.

17. A liquid bottle configured to store recording liquid, the liquid bottle comprising:
a connection port through which recording liquid is to be supplied to a tank, the connection port being configured to be connected to a connection receiving port of the tank;
a protrusion having the connection port, the protrusion being configured to be inserted in a hole, the hole having a cylindrical shape and surrounding the connection receiving port of the tank,
wherein a shape of an outer peripheral surface of the protrusion in an axial direction in which a center axis of the protrusion extends corresponds to a shape of the hole, the outer peripheral surface of the protrusion in the axial direction being not rotationally symmetrical about a center of the protrusion.

18. The liquid bottle according to claim 17, further comprising:
a bottom wall having an annular shape, the protrusion being positioned at the bottom wall; and
a first rib positioned outward from the protrusion, the first rib being apart from the protrusion, the first rib protruding from the bottom wall and surrounding the outer peripheral surface of the protrusion.

19. The liquid bottle according to claim 17,
wherein the liquid bottle is a plurality of the liquid bottles,
wherein the outer peripheral surface of the protrusion has a first curved surface convex outward and a first flat surface continuous with the first curved surface,
wherein the protrusion includes a first rib extending from the first flat surface in a direction orthogonal to the first flat surface, and
wherein positions of the first ribs relative to the respective first flat surfaces in the liquid bottles are different from one another.
